(19) United States
(12) Patent Application Publication
(10) Pub. No.: US 2020/0265394 A1
(43) Pub. Date: Aug. 20, 2020

(54) INFORMATION PROCESSING PROGRAM, METHOD, DEVICE, AND SYSTEM

(71) Applicant: LINE Pay Corporation, Tokyo (JP)

(72) Inventors: Kei KUBO, Tokyo (JP); Yoshio SATO, Tokyo (JP); Tomohiro OKADA, Tokyo (JP); Yohei FUSAYASU, Tokyo (JP)

(73) Assignee: LINE Pay Corporation, Tokyo (JP)

(21) Appl. No.: 16/868,841

(22) Filed: May 7, 2020

Related U.S. Application Data
(63) Continuation of application No. PCT/JP2018/040050, filed on Oct. 29, 2018.

(30) Foreign Application Priority Data
Nov. 7, 2017 (JP) 2017-214764
Nov. 7, 2017 (JP) 2017-214765
Nov. 7, 2017 (JP) 2017-214766
Nov. 7, 2017 (JP) 2017-214767

(51) Int. Cl. G06Q 20/10; G06Q 20/06

(52) U.S. Cl. CPC G06Q 20/102; G06Q 20/065

(57) ABSTRACT

Payment processing techniques and management control techniques concerning improved split bills and cost sharing are provided. A method for performing adjustment of payment between a first user associated with a first information processing terminal registered in a group managed on a server and one or more second users associated with one or more second information processing terminals registered in the group includes displaying the one or more second users associated with the one or more second information processing terminals on a screen of the first information processing terminal, and selecting persons who accept payment from the displayed one or more second users, via an interface on the screen of the first information processing terminal.

### CROSS-REFERENCE TO RELATED APPLICATIONS

This application is a continuation of, and claims the benefit of priority under 35 U.S.C. § 119 from PCT International Application No. PCT/JP2018/040050, which has an International filing date of Oct. 29, 2018 and designates the United States of America, which claims priority to Japanese Patent Application Nos. 2017-214764, 2017-214765, 2017-214766, and 2017-214767 filed on Nov. 7, 2017 in the Japanese Patent Office (JPO), the entire disclosure of each of which is incorporated herein by reference.

### BACKGROUND

### Technical Field

The present inventive concepts relate to information processing methods, devices, and/or systems that perform money collection processing from users, payment processing among users and the like widely through a network, and more specifically, relates to methods, devices, and/or systems for managing and controlling money collection processing, payment processing and the like by controlling electronic value including electronic settlement.

### Description of Related Art

In recent years, settlement via electronic value such as credit cards and electronic money has become widespread. For example, processing a split bill payment or the like that is performed when a plurality of people have a meal together via a credit card is called a split (split the check) or the like, and is widely used in the United States and other countries. Settlement through electronic value has evolved in a wide variety of ways so far.

For example, there is proposed a system that reduces a risk of a loss occurring to an issuer of prepaid payment means using a credit card mechanism

Such information processing system includes a determining unit that sets the usage limit amount and the guarantee amount of each of users within the range of a prepaid amount paid by each of a plurality of users who applied for the prepaid payment means available at a member store of the postpaid payment means, a pool storage unit that stores a pool amount that is used for payment to a sales invoice from the member store, with an amount exceeding the remaining amount of the prepaid payment means and that is a total amount of guarantee money of the plurality of users, and a changing unit that adds guarantee amount to the pool amount stored in the pool storage unit every time the guarantee amount is set by the determining unit.

Further, there is also proposed a system that accepts a reservation that enables settlement with a credit card when credit returns even if there is no credit for settling a usage fee with the credit card that the user wants to use, at the time of the reservation.

Such information processing device includes reservation unit that accepts reservation, and causes storage means to store information on a specified credit card when validity of the specified credit card cannot be confirmed to a request of reservation in which the usage fee is settled by the credit card after a date of use of the service, verification unit that verifies validity of the specified credit card, based on the information stored in the storage means after the reservation is accepted by the reservation means, and output unit that outputs information indicating that a settlement method is settlement by the specified credit card when the specified credit card can be verified as valid by the verification unit, and outputs information indicating that the settlement method is a method different from the settlement by the specified credit card when the specified credit card cannot be verified as valid by the verification unit.

Further, there is also proposed an information processing server that enhances user convenience by combining a stored-value and a server-managed settlement systems.

Such information processing server connects to a money terminal having a function of storing first electronic value, and increasing and reducing a balance of the first electronic value by using predetermined amount change information, and executes settlement processing of a specified settlement amount. Such information processing server includes identification data acquisition unit that acquires identification data from the money terminal, and shortage amount reduction unit that generates the amount change information for reducing the balance of the first electronic value by at least the shortage amount and transmits the amount change information to the money terminal, when it is determined that a shortage amount occurs when the specified settlement amount is settled by second electronic value stored in storage unit on a server side by being associated with the acquired identification data.

Further, there is also proposed a system that reduces a possibility that a representative is notified of the contents of information for settlement of payment when the representative receives the information for settlement of payment from each member and transmits the information to the store, in order to clarify the responsibility concerning payment in the payment by split of the check.

Such system is configured so that when a split amount determined by the representative splitting a total amount sent from a store terminal by a representative terminal is notified to a credit company server from each member terminal as a payment amount, the credit company server retains information for settlement of payment, and transmits payment permission information including encryption information in which the information is encrypted to each of the member terminals, each of the member terminals transmits payment permission information of the same content as the payment permission information to the representative terminal and the representative terminal transmits payment permission information combining the payment permission information to the store terminal.

Further, there is also proposed a credit card system that can realize multi-stage split-bill payment.

Such credit card system includes notification unit that notifies a member different from a credit card member, of request information for requesting that a part of credit card payment amount by the credit card member is split and paid, and split information generating unit that generates split information including a correspondence between a split source and a split destination and respective credit card payment amounts when the member receiving a notice of the request information by the notification unit performs credit card payment for a part of the credit card payment amount, wherein the notification unit is configured to notify another member different from a member who is the split destination in preceding sprit-bill payment, of request information for requesting that a part of a credit card payment amount by the member who is the split destination in the preceding split-bill payment is made a split-bill payment, and the split information generation unit is configured to generate split information including a correspondence between a split source and a split destination and respective credit card payment amounts when the other member receiving the notice of the request information by the notification unit performs credit card payment for a part of the credit card payment amount by the member who becomes the split destination.

Further, there is also proposed an accounting processing device that can perform shared payment processing that divides and allocates the amount of a single item to a plurality of people who share the single item when the ordered single item is shared by the plurality of people.

Such accounting processing device performs accounting processing concerning a payment amount of an ordered item such that when a group formed of a plurality of people orders a single item formed of a single product, shared payment processing in which the amount of the ordered single item is divided and allocated to the plurality of people who ordered the item.

In such accounting processing device, when each person individually pays for each product ordered by the person as the split-bill payment processing by a plurality of people, a list of ordered products for individual payment processing in which products with a plurality of orders are divided into individual items is displayed, when shared payment processing in which the amount of the single item is divided is further necessary, the product is selected, the number of people to perform shared payment is registered, the product is displayed on the screen in a form divided into the number of people, after which, the people corresponding to them are specified, the amount obtained by adding up the individual payment amount and the shared payment amount is calculated for each of the people, and the amount is displayed on the screen, whereby accounting processing is performed.

### SUMMARY

Some conventional techniques disclose devices for electronic settlement of individuals, but there is room for improvement in electronic settlement in a group configured by a plurality of members. Some conventional techniques disclose the systems for processing payments related to split of bills and shares, but there is still room for further improvements in processing of post-payment, post-collection and the like, management control and the like.

Further, it is further desired to provide new techniques (a dunning technique, an interface technique and the like) that can smoothly advance these exchanges and variation techniques.

According to an example embodiment, a method for performing adjustment of payment between a first user associated with a first information processing terminal registered in a group managed on a server, and one or more second users associated with one or more second information processing terminals registered in the group, includes causing the one or more second users associated with the one or more second information processing terminals to be displayed on a screen of the first information processing terminal, and causing persons who accept payment to be selected from the displayed one or more second users, via an interface on the screen of the first information processing terminal.

According to an example embodiment, an information processing terminal includes a processor configured to execute computer-readable code such that the processor causes the information processing terminal to perform adjustment processing of payment between users registered in a group managed on a server, the users including a first user associated with the information processing terminal and one or more second users associated with one or more other information processing terminals, the adjustment processing including displaying one or more second users on a screen of the information processing terminal, and accepting an input of selecting persons who accept payment from the displayed one or more second users via an interface on the screen.

According to an example embodiment, a method for performing adjustment of payment between a first user associated with a first information processing terminal and one or more second users associated with one or more second information processing terminals, includes enabling conversations between the first user associated with the first information processing terminal and the one or more second users associated with the second user terminals via a chat room managed on a server, transmitting a payment request to the second information processing terminals, receiving responses from the second information processing terminals, and requesting the server to manage payment methods and payment deadlines of the second users associated with the second information processing terminals based on the responses from the second information processing terminals.

According to an example embodiment, an information terminal includes a processor configured to execute computer-readable code such that the processor causes the information processing terminal to perform adjustment processing of payment between users registered in a group managed on a server, the users including a first user associated with the information processing terminal and one or more second users associated with one or more other information processing terminals, and the adjustment processing including enabling conversations between the first user associated with the information processing terminal and the one or more second users associated with the one or more other information processing terminals via a chat room managed on the server, transmitting a payment request to the one or more other information processing terminals, receiving responses from the one or more other information processing terminals, and requesting the server to manage payment methods and payment deadlines of the second users associated with the one or more other information processing terminals based on the responses from the one or more other information processing terminals.

According to the present inventive concepts, the payment processing technique and/or the management control technique concerning improved split of bill and cost sharing can be provided.

### BRIEF DESCRIPTION OF THE DRAWINGS

FIG. 1 is an explanatory diagram explaining an entire configuration of an information processing system according to one example embodiment of the present inventive concepts.

FIG. 2 is an explanatory view explaining a configuration example of a system, a device or the like showing a variation of FIG. 1.

FIG. 3 is an explanatory diagram explaining an operation example in the system, the device or the like according to one example embodiment of the present inventive concepts.

FIG. 4A is a flowchart explaining an operation concept flow in the system or the like according to one example embodiment of the present inventive concepts.

FIG. 4B is a flowchart showing a more detailed operation example in the system or the like according to one example embodiment of the present inventive concepts.

FIG. 4C is a flowchart showing a more detailed operation example in the system or the like according to one example embodiment of the present inventive concepts.

FIG. 5 is an explanatory diagram explaining function concepts of operations in the system or the like according to one example embodiment of the present inventive concepts.

FIG. 6 is an explanatory diagram explaining processing and a flow of data among devices or terminals in the system or the like according to one example embodiment of the present inventive concepts.

FIG. 7 is an explanatory view explaining a screen display example on a device or a terminal in the system or the like according to one example embodiment of the present inventive concepts.

FIG. 8 is an explanatory view explaining a screen display example on the device or the terminal in the system or the like according to one example embodiment of the present inventive concepts.

FIG. 9 is an explanatory view explaining a screen display example on the device or the terminal in the system or the like according to one example embodiment of the present inventive concepts.

FIG. 10 is an explanatory view explaining a screen display example on the device or the terminal in the system or the like according to one example embodiment of the present inventive concepts.

FIG. 11A is an explanatory view explaining a screen display example on the device or the terminal in the system or the like according to one example embodiment of the present inventive concepts.

FIG. 11B is an explanatory view explaining a screen display example on the device or the terminal in the system or the like according to one example embodiment of the present inventive concepts.

FIG. 12 is a flowchart showing an operation example in a system or the like according to another example embodiment of the present inventive concepts.

FIG. 13 is a flowchart showing an operation example in a system or the like according to another example embodiment of the present inventive concepts.

FIG. 14 is a flowchart showing an operation example in a system or the like according to another example embodiment of the present inventive concepts.

FIGS. 15A and 15B are explanatory views explaining a screen display example on a device or a terminal in a system or the like according to some example embodiments of the present inventive concepts.

FIG. 16 is an explanatory view explaining a screen display example on a device or a terminal in a system or the like according to another example embodiment of the present inventive concepts.

FIGS. 17A and 17B are explanatory views explaining a screen display example on a device or a terminal in a system or the like according to another example embodiment of the present invention.

FIG. 18 is an explanatory view explaining a screen display example on a device or a terminal in a system or the like according to another example embodiment of the present inventive concepts.

FIGS. 19A to 19D are explanatory views explaining a screen display example on a device or a terminal in a system or the like according to another example embodiment of the present inventive concepts.

### DESCRIPTION

### <Confidentiality of Communications>

It should be noted that the disclosure described in the present disclosure is implemented in compliance with legal matters concerning communication confidentiality.

Some example embodiments for carrying out an information processing system and the like according to the present disclosure will be described with reference to the drawings.

### <System Configuration>

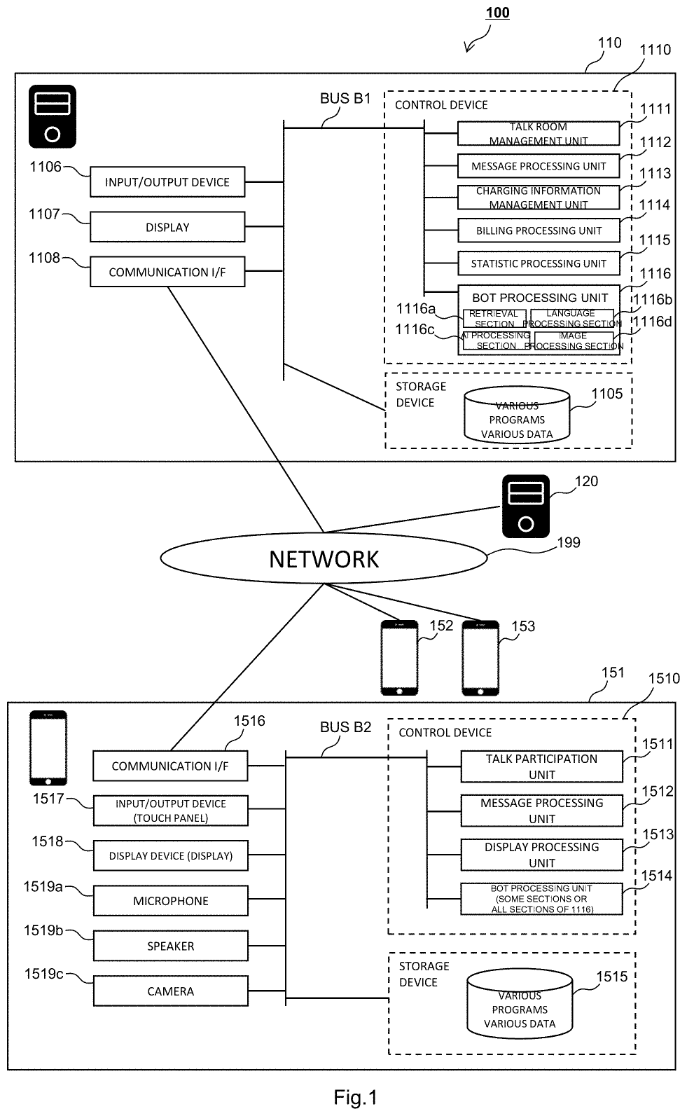

FIG. 1 is a diagram showing a configuration of an information processing system in one example embodiment of the present disclosure. As shown in FIG. 1, in an information processing system 100, one or more servers (a server 110, a server 120) and one or more terminals (a terminal 151, a terminal 152, a terminal 153) are connected via a network 199. The servers 110 and 120 provide service that realizes transmission and reception of messages among the terminals via the network 199 to the terminals 151 to 153 owned by users. The number of terminals that are connected to the network 199 is not limited. Further, the number of servers is not limited, either (A server for extending functionality can be added as necessary. A single server may be caused to provide the service).

As shown in FIG. 1, the network 199 has a function of connecting one or more servers to one or more terminals. In other words, the network 199 means a communications network that provides a connection path so that the terminals 151 to 153 can transmit and receive data after connecting to the server 110 or 120.

For example, one or a plurality of parts of the network 199 may be a wired network or a wireless network. The network 199 can include an ad hoc network (ad hoc network), an intranet, an extranet, a virtual private network (virtual private network: VPN), a local area network (local area network: LAN), a wireless LAN (wireless LAN: WLAN), a wide area network (wide area network: WAN), a wireless WAN (wireless WAN: WWAN), a metropolitan area network (metropolitan area network: MAN), a part of the Internet, a part of a public switched telephone network (Public Switched Telephone Network: PSTN), a mobile phone network, ISDNs (integrated service digital networks), wireless LANs, LTE (long term evolution), CDMA (code division multiple access), Bluetooth (Bluetooth (registered trademark)), satellite communication and the like, or combinations of two or more of them. However, in the present disclosure, the network 199 is not limited to them. Further, the network 199 can include one or a plurality of networks.

The terminals (the terminal 151, the terminal 152, the terminal 153) may be any terminals if only the terminals are information processing terminals that can realize functions described in the respective example embodiments. The terminals 151 to 153 are typically smartphones, and further include mobile cell phones (for example, feature phones), computers (for example, desktops, laptops, tablets or the like), media computer platforms (for example, cables, satellite set top boxes, digital video recorders), handheld computer devices (for example, PDA (personal digital assistant), electronic mail clients or the like), wearable terminals (glasses type devises, watch type devices or the like), or other kinds of computers, or communication platforms. However, in the present disclosure, the terminals 151 to 153 are not limited to these terminals. Further, the terminals 151 to 153 may be expressed as information processing terminals.

Because configurations of the terminals 151 to 153 are the same, in the following explanation, the terminal 151 will be described as a representative, and the terminal 152 and the terminal 153 will be described hereinafter as other terminals as necessary. Similarly, with respect to the servers 110 and 120, the server 110 will be described as a representative.

The server 110 includes a function of providing a predetermined service to the terminal 151 and the like. The server 110 may be any device if only the device is an information processing device that can realize the functions described in some example embodiments. The server 110 is typically a server device, and further includes a computer (for example, a desktop, a laptop, a tablet or the like), a media computer platform (for example, a cable, a satellite set top box, a digital video recorder), a handheld computer device (for example, a PDA, an electronic mail client, or the like), or other kinds of computers, or a communication platform. However, in the present disclosure, the server 110 is not limited to these devices. Further, the server 110 may be expressed as an information processing device.

### <Hardware (HW) Configuration>

With use of FIG. 1, HW configurations of the respective devices included in the communication system will be described.

(1) HW Configuration of Terminal

The terminal 151 includes a control device 1510 (CPU: central processing unit (central processing unit)), a storage device 1515, a communication I/F 1516 (interface), an input/output device 1517, a display device 1518, a microphone 1519a, a speaker 1519b, and a camera 1519c. The respective components of HW of the terminal 151 are connected to one another via a bus B2, for example.

The communication I/F 1516 performs transmission and reception of various data via the network 199. The communication may be executed wirelessly or by wire, and any communication protocol may be used if only mutual communication can be executed. The communication I/F 1516 has a function of executing communication with the server 110 via the network 199. The communication I/F 1516 transmits various data to the server 110 according to an instruction from the control device 1510. Further, the communication I/F 1516 receives various data transmitted from the server 110, and transmits the various data to the control device 1510.

The input/output device 1517 includes a device that receives various operations to the terminal 151, and a device that outputs a processing result processed by the terminal 151. The input/output device 1517 may have the input device and the output device integrated, or may be separated into the input device and the output device (in the case of the latter, separated into an input device 1517a such as a touch panel input sensor, and an output device 1517b such as a touch panel output sensor, a vibration drive mechanism or the like, as an example).

The input device is realized by any one or a combination of all kinds of devices that can accept input from the user and can transmit information relating to the input to the control device 1510. The input device is realized typically by a touch panel or the like, detects contact by a finger of the user or a pointer such as a stylus, and a contact position thereof, and transmits coordinates of the contact position to the control device 1510. On the other hand, the input device may be realized by an input device other than touch panels. The input device includes, for example, a hardware key represented by a keyboard or the like, a pointing device such as a mouse, a camera (operation input via a moving image), or a microphone (operation input by voice). However, in the present disclosure, the input device is not limited to these devices.

The output device is realized by any one or a combination of all kinds of devices that can output a processing result processed by the control device 1510. The output device is realized typically by a touch panel or the like. On the other hand, the output device may be realized by an output device other than touch panels. For example, the output device can include a speaker (voice output), a lens (for example, 3D (three dimensions) output, hologram output), a printer or the like. However, in the present disclosure, the output device is not limited to these devices.

The display device 1518 is realized by any one or a combination of all kinds of devices that can display according to display data written in a frame buffer (not illustrated). The display device 1518 is realized typically by a monitor (for example, a liquid crystal display, an OELD (organic electroluminescence display)). The display device 1518 may be a head mounted display (HMD: Head Mounted Display). Further, the display device 1518 may be realized by a device capable of displaying an image, text information, or the like in projection mapping, a hologram, or in the air (or in a vacuum). Note that these display devices 1518 may be capable of displaying the display data three-dimensionally. However, in the present disclosure, the display device 1518 is not limited to these devices.

When the input/output device 1517 is a touch panel, the input/output device 1517 and the display device 1518 are configured as the devices having substantially the same sizes and shapes, and may be disposed to oppose each other.

The control device 1510 has a circuit physically structured to execute functions realized by a code or a command included in a program, and is realized by, for example, a data processing device incorporated in hardware.

The control device 1510 is typically a central processing unit (CPU), and further may be a microprocessor (microprocessor), a processor core (processor core), a multiprocessor (multiprocessor), an ASIC (application-specific integrated circuit), or a FPGA (field programmable gate array). However, in the present disclosure, the control device 1510 is not limited to these devices.

The storage device 1515 has a function of storing various programs and various data desired when the terminal 151 operates. The storage device 1515 is realized by various storage media such as an HDD (hard disk drive), an SSD (solid state drive), a flash memory, a RAM (random access memory), and a ROM (read only memory). However, in the present disclosure, the storage device 1515 is not limited to these media.

The terminal 151 stores a program P in the storage device 1515, and executes the program p, and thereby the control device 1510 executes processing as each part included in the control device 1510. In other words, the program P stored in the storage device 1515 causes the terminal 151 to realize each function executed by the control device 1510.

The microphone 1519a is used to input audio data. The speaker 1519b is used to output audio data. The camera 1519c is used to acquire moving image data.

(2) HW Configuration of Server

The server 110 includes a control device 1110 (CPU), a storage device 1105, an input/output device 1106, a display 1107, and a communication I/F 1108 (interface). The respective components of HW of the server 110 are mutually connected via a bus B1, for example.

The control device 1110 has a circuit physically structured to execute functions realized by codes or commands included in a program, and is realized by, for example, a data processing device incorporated in hardware.

The control device 1110 is typically a central processing unit (CPU), and further may be a microprocessor, a processor core, a multiprocessor, an ASIC, or an FPGA. However, in the present disclosure, the control device 1110 is not limited to these devices.

The storage device 1105 has a function of storing various programs desired by the server to operate and various data. The storage device 1105 is realized by various storage media such as an HDD, an SSD, and a flash memory. However, in the present disclosure, the storage device 1105 is not limited to these media.

The input/output device 1106 is realized by a device that receives various operations to the server 110. The input/output device 1106 is realized by any one or a combination of all kinds of devices that can accept input from a user and transmit information relating to the input to the control device 1110. The input/output device 1106 is realized typically by a hardware key represented by a keyboard or the like, or a pointing device such as a mouse. The input/output device 1106 may include, for example, a touch panel or a camera (operation input via a moving image), and a microphone (operation input by voice). However, in the present disclosure, the input/output device 1106 is not limited to these devices.

The display 1107 is realized typically by a monitor (for example, a liquid crystal display or an OELD (organic electroluminescence display)). The display 1107 may be a head mounted display (HMD) or the like. Note that these displays 1107 may be capable of displaying display data three-dimensionally. However, in the present disclosure, the display 1107 is not limited to these displays.

The communication I/F 1108 performs transmission and reception of various data via the network 199. The communication may be executed by wire or wirelessly, and any communication protocol may be used if only mutual communication can be executed. The communication I/F 1108 has a function of executing communication with the terminal 151 via the network 199. The communication I/F 1108 transmits various data to the terminal 151 according to an instruction from the control device 1110. Further, the communication I/F 1108 receives various data transmitted from the terminal 151, and transmits the various data to the control device 1110.

The server 110 stores the program P in the storage device 1105, and executes the program P, and thereby the control device 1110 executes processing as the respective parts included in the control device 1110. In other words, the program P stored in the storage device 1105 causes the server 110 to realize respective functions executed by the control device 1110.

Some example embodiments of the present inventive concepts will be described as realized by the CPUs of the terminal 151 and the like and/or the server 110 and the like executing the program P.

The control device 1510 of the terminal 151, and/or the control device 1110 of the server 110 may realize each processing by not only the CPU, but also by a logical circuit (hardware) and an exclusive circuit formed on an integrated circuit (IC (Integrated Circuit) chip, an LSI (Large Scale Integration)) or the like. Further, these circuits may be realized by one or a plurality of integrated circuits, or a plurality of processes shown in some example embodiments may be realized by one integrated circuit. Further, an LSI is sometimes called a VLSI, a super LSI, an ultra LSI or the like depending on the degree of integration.

Further, the program P (software program/computer program) of some example embodiments of the present disclosure may be provided in a state where the program P is stored in a computer-readable storage medium. As for the storage medium, the program is storable in “a non-transitory tangible medium”.

In a suitable case, the storage medium can include one or a plurality of semiconductor-based or other integrated circuits (ICs) (for example, a field programmable gate array (FPGA) or an application specific IC (ASIC) or the like), a hard disk drive (HDD), a hybrid hard drive (HHD), an optical disk, an optical disk drive (ODD), an optical magnetic disk, an optical magnetic drive, a floppy diskette, a floppy disk drive (FDD), a magnetic tape, a solid state drive (SSD), a RAM drive, a secure digital card or drive, an another arbitrary suitable storage medium, or a suitable combination of two or more of these media. The storage medium may be volatile, nonvolatile, or a combination of volatile and nonvolatile in an appropriate case. The storage medium is not limited to these examples, and may be any device or a medium if only the storage medium is capable of storing the program P.

The server 110 and/or the terminal 151 can realize functions of a plurality of functional parts shown in the example embodiment by reading the program P stored in the storage medium and executing the read program P, for example.

Further, the program P according to one example embodiment of the present inventive concepts may be provided to the server 110 or the terminal 151 via an arbitrary transmission medium (a communication network, a broadcast wave or the like) capable of transmitting the program. The server 110 and/or the terminal 151 realize the functions of the plurality of functional parts shown in some example embodiments by executing the program P downloaded via the Internet or the like, for example.

Further, some example embodiments of the present disclosure can also be realized in a format of a data signal buried in the transmission wave, with the program P being embodied by electronic transmission.

At least part of the processing in the server 110 and/or the terminal 151 may be realized by cloud computing configured by one or more computers.

At least part of the processing in the terminal 151 may be configured to be performed by the server 110. In this case, for example, at least some process of the processes of the respective functional parts of the control device 1510 of the terminal 151 may be configured to be performed by the server 110.

At least some of the processes in the server 110 may be configured to be performed by the terminal 151. In this case, for example, at least some processes of the processes of the respective functional parts of the control device 1110 of the server 110 may be configured to be performed by the terminal 151.

In the present disclosure, a configuration of determination is not essential, a desired (or alternatively, predetermined) process is operated when the determination condition is satisfied, or a desired (or alternatively, predetermined) process may be performed when the determination condition is not satisfied.

The program of the present disclosure can be implemented using, for example, a script language such as ActionScript, and JavaScript (registered trademark), an object-oriented programming language such as Objective-C and Java (registered trademark), a markup language such as HTML5, or the like. However, the present disclosure is not limited to these languages.

### <Variation of System Configuration>

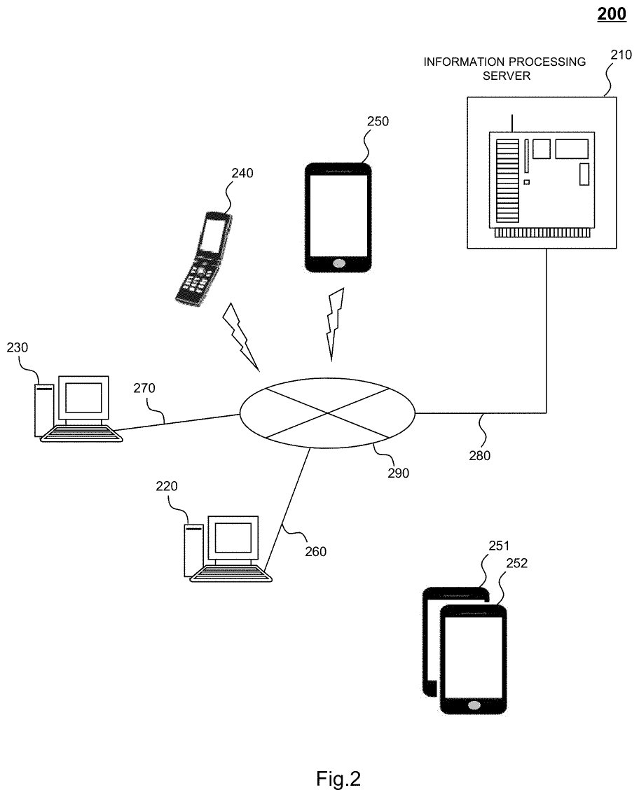

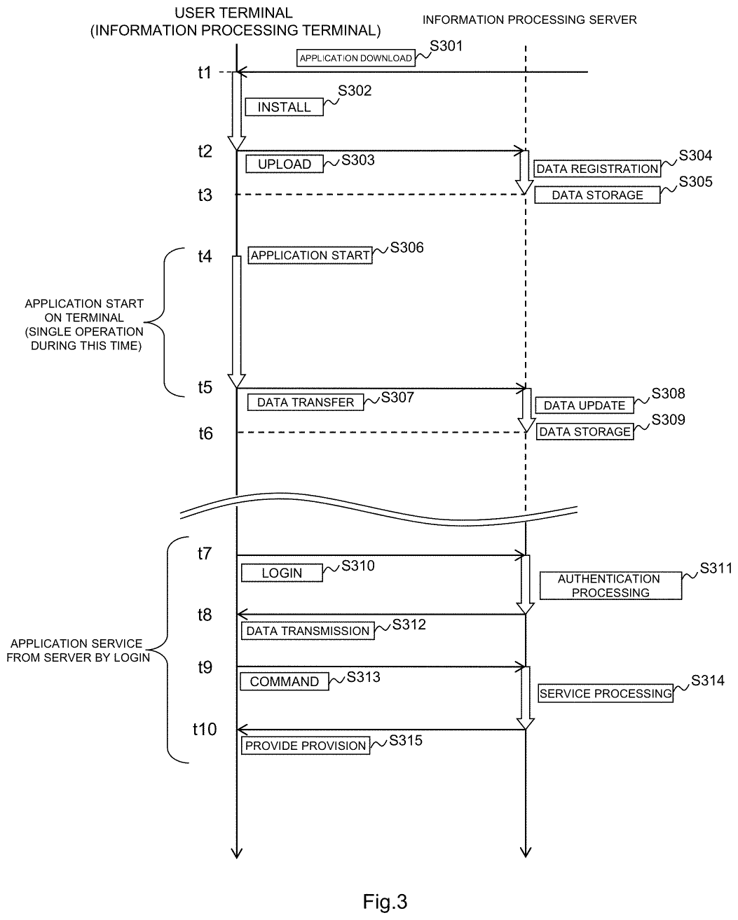

FIG. 2 shows a configuration example of a system, a device or the like showing a variation of FIG. 1. A characteristic processing operation in the configuration shown in FIG. 2 (and FIG. 3) lies in that some example embodiments of the present inventive concepts are realized by not only a cooperative operation of the servers and the terminals via the network, but also is realizable on the terminal single body if desired.

As shown in FIG. 2, an information processing system 200 is configured by an information processing server 210 and various information processing terminals used by users (In FIG. 2, PCs 220 and 230, a mobile cellular phone 240, a mobile information terminal or tablet terminals 250 to 252 are illustratively shown. Hereinafter, also generally called “terminals”) as a minimum configuration thereof, and the server and the various terminals are connected to be mutually communicable by a dedicated line and a public line such as the internet (260, 270, 280 and 290 as wired lines) as shown in FIG. 2. Further, the lines may be wired or wireless, and in the case of wireless line, the mobile cellular phone 240 and the portable information terminal or tablet terminal 250 enters the Internet 290 wirelessly via base stations, wireless routers or the like (not shown), and further connected to the information processing server 210 via the line 280 to be mutually communicable.

Many mobile cellular phones, mobile information terminals or tablets include processing capabilities (communication processing speed, an image processing capability and the like) equivalent to a personal computer (PC), and should be said as compact computers.

Further, a program or software desired to carry out the present inventive concepts is usually installed or stored in HDDs, SSDs or the like in the storage units of a PC and portable information terminals, is read out as a software module of an entire part or a part thereof into the memory in the storage unit as desired at the time of execution of the program or the software, and arithmetic operation is executed in the CPU.

Arithmetic operation execution does not always have to be performed in the central processing unit such as a CPU, but an auxiliary arithmetic operation unit such as a digital signal processor (not shown) can also be used.

Further, a hardware configuration of the information processing server 210 can also adopt a PC. Although the present inventive concepts are not limited to this, the information processing server 210 can also adopt a configuration suitable for processing large-scale data by operating a plurality of PCs (several tens to tens of thousands as an example) in parallel in raising the hardware specifications as necessary.

<Cooperation with Other Systems (not Shown)>

The information processing system according to one example embodiment of the present inventive concepts can complete processing of settlement and the like by properly cooperating with a credit company server, a financial institution server, or a store server (including a member store terminal joining the store) (not shown) if desired in completing processing of settlement, collection or the like which is a feature thereof. In this meaning, not all of a series of processing of settlement or the like need to be completed in the information processing system, according to some example embodiments of the present inventive concepts itself. In other words, the processing in the information processing system according to some example embodiments of the present inventive concepts is sufficient to output at least data such as book data which becomes desired for completing a series of processing of settlement or the like (as a matter of course, performing further processing is not excluded).

### <Variation of Operation Form>

FIG. 3 shows an operation example in a system, a device or the like according to one example embodiment of the present inventive concepts illustrated with reference to FIG. 1 and FIG. 2. FIG. 3 shows that an example operation of the present inventive concepts are realizable by the cooperative operation with the servers and terminals via the network, or are realizable on the single terminal or among the terminals independently from the server.

In FIG. 3, a “user terminal” corresponds to the terminals 151 to 153 in FIG. 1, and the terminals 220, 230, 240 and 250 to 252 in FIG. 2, and an “information processing server” corresponds to the servers 110 and 120 in FIG. 1, and the information processing server 210 in FIG. 2. Further, in FIG. 3, t1 to t10 indicate a time-series flow, and operations and processing described later are performed over time.

Operations or processing times (t1 and the like) illustrated in the example embodiment is illustrated for easy understanding of the present inventive concepts, and the present inventive concepts are not limited by an individual time-series relationship illustrated in the example embodiment.

First, at a time t1, the user downloads application software for operating an own user terminal as the information processing terminal according to some example embodiments of the present inventive concepts from the information processing server via the user terminal (step S301). The application software may be client software or application software for processing a part or an entire part of the program according to some example embodiments of the present inventive concepts. The user installs the downloaded application software in the user terminal (step S302). At this time, in a time t2, the user can upload profile information (step S303) as in the following table to the information processing server in addition to an e-mail address of the user himself or herself as user registration if desired from the user terminal and can also cause the profile information to be registered and managed (step S304).

TABLE 1

| | | | | | |
|---|---|---|---|---|---|
| Name | Membership | e-mail address | Sex | Age | Residence |
| (nickname)) | number | (cellular phone | | (generation) | area |
| | (ID) | number) | | | (country•area) |

Above data items are stored in the storage device on the information processing server as user data (step S305). At a time t3 and thereafter, the user can start the application by operating the information processing terminal (the server starts providing service to the terminal).

Next, the user who downloaded and installed the application to and on the user terminal starts the application software at a time t4 (step S306). From the time t4 to a time t5, the user illustratively enjoys service provided by the information processing terminal.

At the time t5, the user temporarily suspends or terminates the application software according to one example embodiment of the present inventive concepts. At this time, status information on the application is transferred to the information processing server if desired (step S307), and the server receives the status information and updates (step S308) and stores (step S309) the status information as user information of the user. In FIG. 3, these processes are completed by a time t6.

After the application software according to one example embodiment of the present inventive concepts is installed on the information processing terminal, it can, of course, be brought into a form completely closed and executable (e.g., exclusively executable) on the terminal. In this case, steps S304 and step S305, and step S308 and step S309 described above can be omitted, and if there is any information desired to be stored, such information may be stored in the memory on the terminal and managed.

Next, in FIG. 3, in a time t7 to a time t10, an example embodiment in a case of at least part of the application software according to one example embodiment of the present inventive concepts being carried out in the information processing server is illustrated. In this case, the user performs two typical user terminal operations of a login operation and command transmission, and receives data from the information processing server, or receives service provision.

For example, in FIG. 3, when the user performs a login process to the server via their information processing terminal at the time t7 (step S310), the information processing server performs authentication processing as appropriate (step S311), and the server transmits data for receiving service provision (e.g., a top menu screen configured to receive a command from the terminal or an application startup screen) to the user at a time t8 (step S312).

At a time t9, the user transmits some command via the information processing terminal (step S313). The command may be selection of menus displayed on the menu screen, and may be a start command for starting the application in the case of the application startup screen. The server receives the command and starts service processing (step S314). Subsequently, at the time t10, service corresponding to a request of the terminal is provided from the server (step S315).

Though not illustrated in FIG. 3, a command can also be transmitted at any time from the terminal at the time t10 and thereafter (for example, a message transmission command or a menu selection command), and each time, the server can receive command reception from the terminal and provide service (for example, transferring the received message to the other terminal or analyzing the message and returning the result).

Further, in one example embodiment of the present inventive concepts, the user can also transmit a message to a specific person or a specific number of persons from the user terminal (not shown in FIG. 3). The message is relayed by the information processing server, transferred to the specific person or the specific number of persons and received at the side of the specific person or the persons. Further, the transmitted message can also be confirmed in the own terminal.

For example, processing of these message is realized by a functional configuration implemented on the server and the terminal and described later.

### <Functional Configuration>

### (1) Functional Configuration of Terminal

In one example embodiment of the present inventive concepts, as shown in FIG. 1, the terminal 151 has a talk (or chat) participation unit 1511 and a message processing unit 1512, as functions realized by the control device 1510, which is configured to execute the program and the data stored in the storage device 1515.

The talk participation unit 1511 has a function of performing processing for participating in a desired talk room. It is possible to participate in the (or chat) room on an individual basis, and participate in the talk room on a group basis.

In one example embodiment of the present inventive concepts, a BOT server (as an example, the servers 110 and 120, or a server equivalent to these servers) can be provided, and the BOT server can be allowed to participate in the talk room similarly to an individual user by being caused to include respective functions illustrated by referring to the terminal 151 (at this time, the BOT as one user is given one account of instant messenger service similarly to a human user).

Further, a talk room can also be newly generated. By transmitting (saying) a message in a state participating in the talk room, the message is transmitted to other participant terminals 2 participating in the same talk room and/or the BOT server (BOT as one user participating in the talk room) via the server 110 and the like.

Note that BOT is a generic name for computers that perform work and the like on behalf of humans, and named after the robot, and in a narrow sense, BOT is a program that performs automated chat.

In one example embodiment of the present inventive concepts, BOT can also be managed by being linked to one user or a plurality of users, or a group to which one or more users belongs or belong.

The message processing unit 1512 has a function of performing processing of generation and transmission and reception of a message in the talk room, display control of the transmitted and received message on the own terminal and the like. As message processing and display control examples, a received message is displayed on a left side, and a transmitted message is displayed on a right side, with respect to a time axis from top to bottom.

A display processing unit 1513 causes message data processed by the message processing unit 1512 to be displayed on the display device 1518. The display processing unit 1513 has a function of converting display data (as an example, a character code) into pixel information (as an example, a font or a pictorial symbol), and writing the pixel information to a frame buffer (not shown) of the display device 1518.

Further, a BOT processing unit 1514 has a function of a part or all parts of the BOT processing unit 1116 on the server 110 described later.

### (2) Functional Configuration of Server

In one example embodiment of the present inventive concepts, as shown in FIG. 1, the server 110 has a talk room management unit 1111, a message processing unit 1112, a charging information management unit 1113, a billing processing unit 1114, a statistic processing unit 115 and the BOT processing unit 1116, as functions realized by the control device 1110, which is configured to execute the program and data stored in the storage device 1105.

The talk room management unit 1111 has a function of managing participants and the like of the talk room.

The message processing unit 1112 has a function of transmitting (transferring) a same message to the other participant terminals (for example, the terminals 152 and 153) as destinations and/or the BOT server (for example, the server 120) when receiving the message transmitted in a specific talk room from the terminal 151.

The charging information management unit 1113 performs calculation processing and management for charging a user (also including BOT) account, for example, according to provision of a message to be charged.

The billing processing unit 1114 performs billing processing for each user (also including BOT) account, for example, based on the charging information processed and managed in the charging information management unit 1113.

The statistic processing unit 1115 performs statistic processing from various viewpoints based on data processed in the charging information management unit 1113 and/or the billing processing unit 1114 and stores and manages the result of the static processing.

The BOT processing unit 1116 performs processing of performing work, making judgement, giving advice and the like in place of a user (human). For example, processing modules are included, such as a retrieval section 1116a for retrieving suitable data, a language processing section 1116b for processing languages (including an audio language) included in transmission and reception messages, an AI processing section 1116c that judges meanings and value of the processed language or the like and performs learning based on success or failure of the judgement result and the like, and an image processing section 1116d that performs analysis processing of a given image, recognition processing of a transferred object and the like, though the present inventive concepts are not limited to these modules.

As described above, the BOT server (as an example, the servers 110, 120, or a server equivalent to these servers) can be caused to exhibit the same functions as those of the individual user by including the respective functions illustrated with reference to the terminal 151 (at this time, the BOT as one user is given one account of instant messenger service similarly to the human user). The assistant BOT that is caused to function by the BOT server and the human user can establish a desired (or alternatively, predetermined) relationship with each other by having a friendship with each other (linking accounts) or the like (the desired (or alternatively, predetermined) relationship like this is appropriately described in a database or a relationship table (not shown) and managed).

### First Example Embodiment

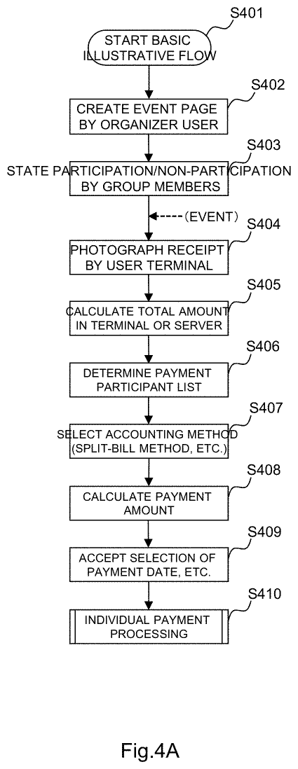

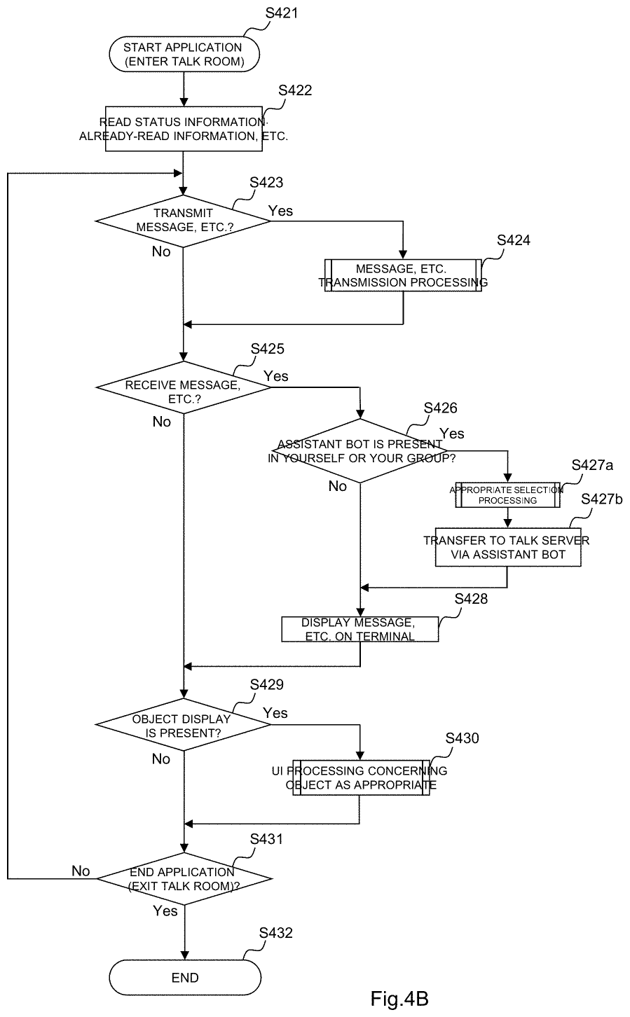

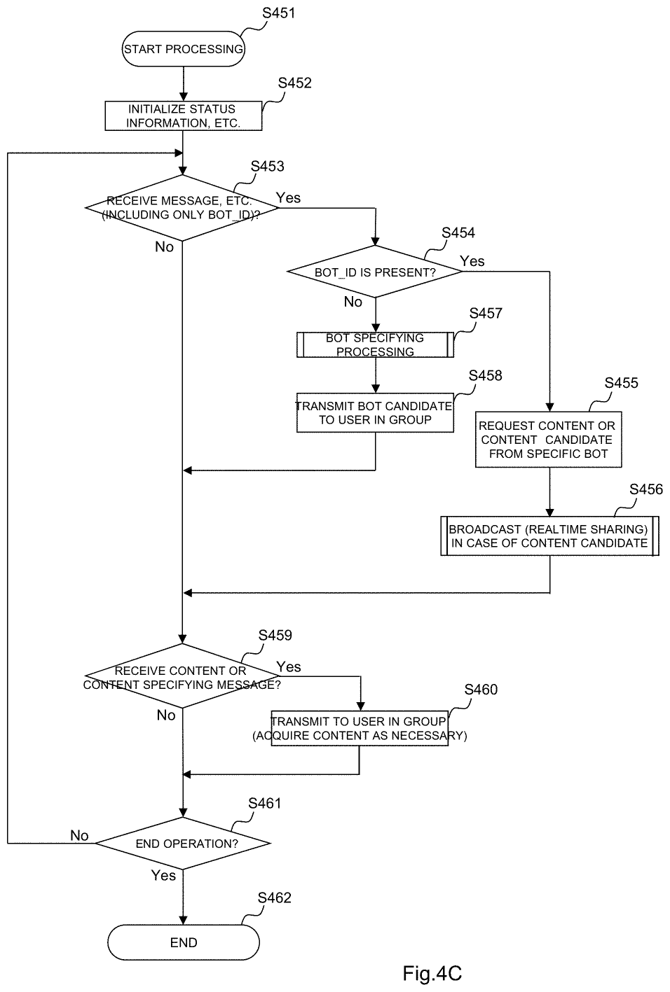

A first example embodiment describes an operation flow when a user participating in a talk room managed by a server or the like (as an example, a “talk server” described later) transmits and receives messages via a terminal, creates an event page in the talk room, performs exchange with an assistant (BOT) of user or a group as desired, causes the assistant (BOT) to perform exchange, selects an account method among group members recruited on the event page, and performs payment processing among the members, an operation of the talk server, and an operation of a BOT server participating in the talk room as one user (one account) (described later with reference to FIG. 4A to FIG. 6).

Some or all of the contents described in the first example embodiment are also applicable to other example embodiments, except where the features are mutually exclusive.

In one example embodiment of the present inventive concepts shown in FIG. 4A to FIG. 6, a talk server (the server 110 or the like in FIG. 1 corresponds to the talk server) assumes a role of a server providing a messaging service. Further, in one example embodiment of the present inventive concepts, the BOT server (the server 110 or the like in FIG. 1 corresponds to the BOT server) participating in the talk room as one user (one account) similarly to the user terminal is introduced.

FIG. 4A is an operation flow that summarizes an outline of each process that occurs when a member of a talk room or the like attends an event such as a food and drink party and pays for the expense through an information system according to one example embodiment of the present inventive concepts. As a premise of FIG. 4A, one of the members (for example, an organizer of the event in the group, another member who would like to attend the event, or the like) enters and exits the talk room as appropriate at a time of start of the operation flow. In the talk room, messages and the like are exchanged.

When an example flow is started in step S401 in FIG. 4A, a flow proceeds to step S402, and an organizer user creates an event page via an own terminal as an example. The event page can be provided independently on the server, but the present inventive concepts are not limited to this, and the event page can also be provided by being linked to the talk room (or, in the talk room), for example. Hereinafter, for easy understanding of the present inventive concepts, the event page is installed by being linked to the talk room, or is installed in the talk room.

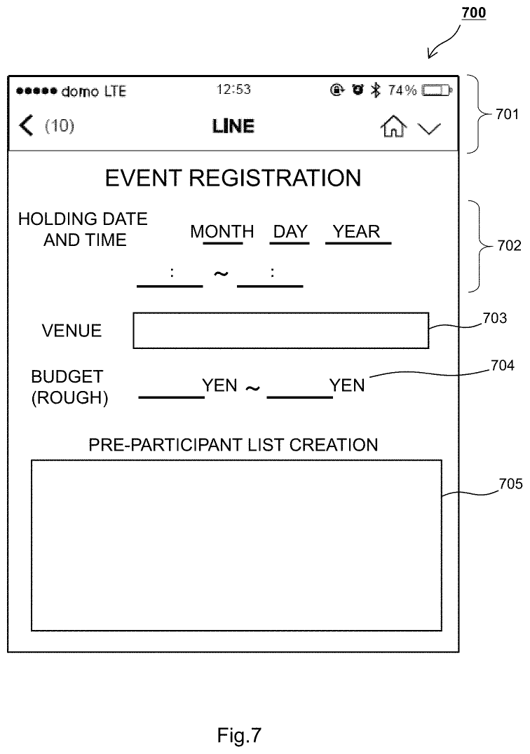

Here, an event registration screen example for the organizer user to create an event page via the own terminal is shown in FIG. 7. FIG. 7 shows a screen 700 of the user terminal (A casing part of the terminal is omitted, and only a display part is shown. The same applies hereinafter). In addition to terminal status information 701 displayed on an upper part of the screen 700, a holding date and time input field 702, an event holding venue input field 703, an event budget input field 704, and a pre-participant list creation field 705 are displayed, as bibliographic items for event registration. Further, it is also possible to enter an event name separately, though not shown in FIG. 7.

The organizer user performs event registration via the screen 700 illustrated in FIG. 7, creases an event page (not shown) on the server or the like, and can call for participation in the event by announcement or the like via the talk room.

In step S403, a group member who receives announcement or the like of holding the event by the processing in the previous step performs statement of participation in the event (or statement of non-participation). Statement of participation/non-participation like this can also be performed via the user terminal and the talk room.

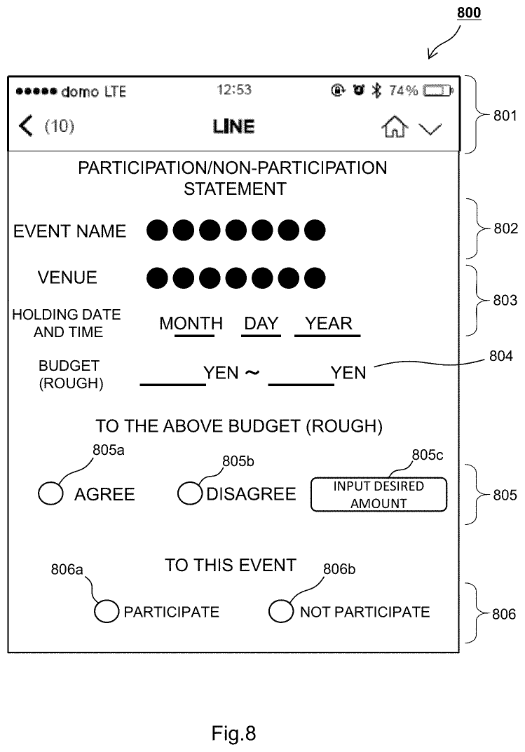

Here, FIG. 8 shows an example of a contact screen for a group member to perform statement of participation/non-participation in the event via the own terminal. FIG. 8 shows a screen 800 of the user terminal. In addition to terminal status information 801 displayed on an upper part of the screen 800, a title “Participation/non-participation statement”, an event name display field 802, an event holding venue and holding date and time display field 803, and an event budget display field 804 are displayed.

The group member states participation/non-participation or the like in the event via the screen 800 illustrated in FIG. 8. For example, the group member can express his or her intention by input to an answer field 805 for agreeing/disagreeing or the like to the budget, and a participation/non-participation answer field 806.

For example, when the group member agrees to the budget, the group member presses a check button 805a, and presses a check button 805b when the group member disagrees to the budget. Further, the group member can also input a desired amount of budget if desired. In this case, the member presses a button 805c, and inputs a desired amount in the screen not illustrated. When the member participates in the event, the member presses a check button 806a, and presses a check button 806b when the member does not participate in the event. Answer contents are recorded and managed by being uploaded to the server or the like.

### [Guarantor Setting]

In one example embodiment of the present inventive concepts, for example, at a time point of the statement of participation/non-participation in the event, a guarantor for payment can be set. This flexibly reflects in the system the custom or the like that a senior pays the cost if the junior cannot pay, or a parent pays the cost for the child, in advance, and these relationships can be linked to the database or a management table of the server or the like via a guarantee request via a request screen (requester side terminal) (not shown), and a consent process via a consent screen (guarantor side terminal) (not shown).

Note that as for “guarantor” setting, even a user registered in the same talk room seen from the setting user, or even a user registered in a different talk room can be set as the guarantor.

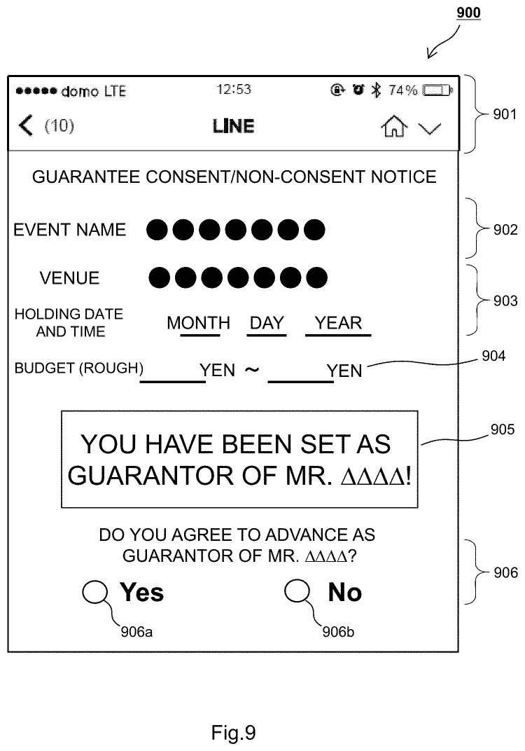

FIG. 9 shows a notification screen example on a terminal on a guarantor (user) side receiving a guarantee request. FIG. 9 shows a screen 900 of a user terminal requested for guarantee. In addition to a terminal status 901 displayed on an upper part of the screen 900, a notification title “Guarantee consent/non-consent notice”, an event name display field 902, an event holding venue and holding date and time display field 903, and an event budget display field 904 are displayed.

Further, a message 905 notifying that another user in the group has requested a guarantee for payment of the event fee is also displayed.

The user who receives this can make a reply as to whether or not the user agrees to pay advance on behalf of the requester as a guarantor of the requester via an answer field 906. For example, when the user agrees to pay the advance as the guarantor of the requester, the user presses a check button 906a, and presses a check button 906b when the user does not agree. The replay content is recorded and managed by being uploaded to the server or the like.

### (Variation of Advance Payment Method by Guarantor)

An advance payment method as the guarantor includes many variations such as a method in which the guarantee side also pays the expense of the requester in advance, in addition to a method in which when the requester cannot pay, the guarantor pays the expense on behalf of the requester after the event, as described above, and such variations can be stored and managed in the server or the like by using flags or the like.

Returning to FIG. 4A again, when step S403 is ended, an event (an event such as a meal or a function, a rehearsal or exercise in a shared space, in which each participant will bear a cost) is held on a date and time (not shown) in a place (not shown). As a matter of course, during the event, the users perform communications via the talk room. This includes, for example, questions and answers on how to get to the venue, making an individual appointment for a meeting between the members living in the neighborhood and the like.

In step S404, the event ends, and in order to start accounting work, the organizer photographs a receipt or an acknowledgement on which the cost spent at the venue is written with the own terminal (equipped with a CMOS camera or the like not shown), as an example. At this time point, a representative (the organizer, as an example) advances the cost on behalf of the other members by lump-sum card payment or the like, though the present inventive concepts are not limited to this. The receipt or the acknowledgement describes the breakdown of the contents of the food and drink and a total amount in the case of a meal at a restaurant or the like, and when the members rent the venue and practice or the like, the amount of a venue usage fee and the like is described. For example, the receipts are printed, but are not intended to exclude handwritten receipts.

In one example embodiment of the present inventive concepts, the receipt or the acknowledgement photographed with the user terminal (the organizer terminal or the like) is or recognized and digitized by using, for example, character recognition technique, and stored and managed on the user terminal and/or the server.

When there are a plurality of receipts, or donations are previously received from non-participants (contribution is received), aggregation work is desired, so that calculation processing of the total amount (total amount of money that should be paid by the participants) is performed on the user terminal and/or the server in step S405.

When the processing in step S405 described above is not desired, or when the total amount is already known in step S404, step S405 is omitted.

Next, the flow proceeds to step S406, and payment participants are determined among the event participants (that is, in principle, people who are obliged to pay). Those who have seniors or parents arranged to pay for the cost on their behalf are excluded by the aforementioned pre-processing even they participated in the event. In some example embodiments, those who have stated non-participation in the event, or have not stated participation/non-participation, but participated in the event unexpectedly can be added to the list of the payment participants at this time point.

In this way, the payment participant list is determined via the organizer terminal or the like. The determined list is stored and managed on the user terminal and/or the server.

In step S407, an account method is selected concerning in what distribution (e.g., distribution rule) the payment participants bear the payment. While a simplest payment method is so-called splitting the check, in some example embodiments of the present inventive concepts, various payment methods can be flexibly selected with an intelligible interface (details will be described later).

Next, the flow proceeds to step S408, and a payment amount for each of the payment participants is calculated. A calculated result is stored and managed on the server, and can be notified to the terminal of each of the payment participants.

In step S409, reception of selection of a payment time and payment method, and the like is performed on the terminal of each of the payment participants. Received contents are stored and managed on the server.

In step S410, payment processing is individually (via the user terminals) carried out based on the individual payment relationships managed on the server.

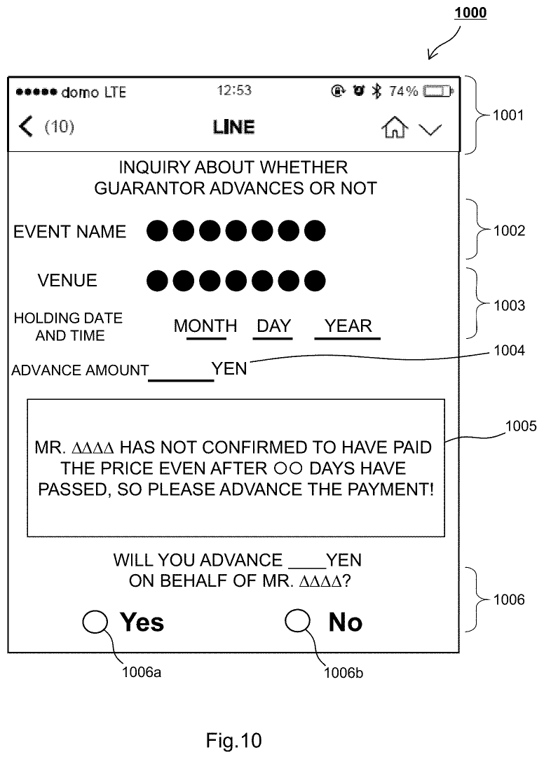

FIG. 10 shows a notice screen example on the terminal on the guarantor (user) side who accepts the guarantee request. FIG. 10 shows a screen 1000 of the user terminal that accepts the guarantee request. In addition to a terminal status 1001 displayed on an upper part of the screen 1000, a notice title “Inquiry about whether guarantor advances or not”, an event name display field 1002, an event holding venue and holding date and time display field 1003, and an event cost advance payment amount display field 1004 are displayed.

Further, a message 1005 notifying that the other user who accepted the guarantee request in the group has not paid the price yet even after a desired (or alternatively, predetermined) time period elapsed is also displayed.

The user who received this can give an instruction of whether or not to execute advance as the guarantor of the requester via an instruction field 1006. For example, when the user executes advance as the guarantor of the requester, the user presses a check button 1006a, and presses a check button 1006b when the user does not want to execute advance. These instruction commands are recorded and managed by being uploaded to the server, or the like, and settlement processing is performed by cooperation with a settlement server (not shown) as appropriate.

[Late Payment Notice to “Friend” Other than Guarantor]

In one example embodiment of the present inventive concepts, besides the aforementioned guarantor function, a “friend” can be set, who does not guarantee for payment but is notified that the user has not finished (delayed) payment. This aims to urge payment or repayment of a member by giving a delay notice to a person (for example, a parent, a best friend, a lover or the like) whom the member does not want to know the fact, when the member leaves unpaid (delayed).

The “friend” setting like this can be made mutually among the members in advance, or can be made by causing a person who became the guarantor in the past to take over as the “friend” setting, or automatically registering particularly close persons to “friends” as the mutual delay notification destinations based on communication records in the talk room.

Note that as “friend” setting, even a user registered in the same talk room seen from the user of a setting source, or even a user registered in a different talk room can be set as the friend.

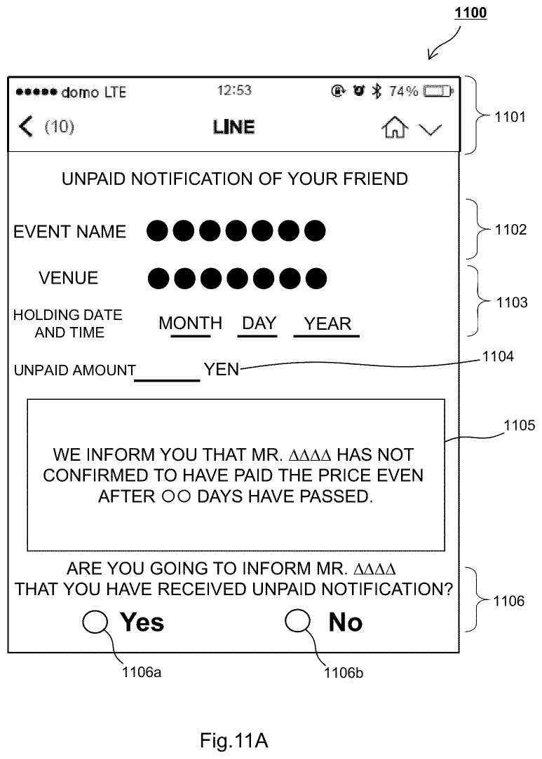

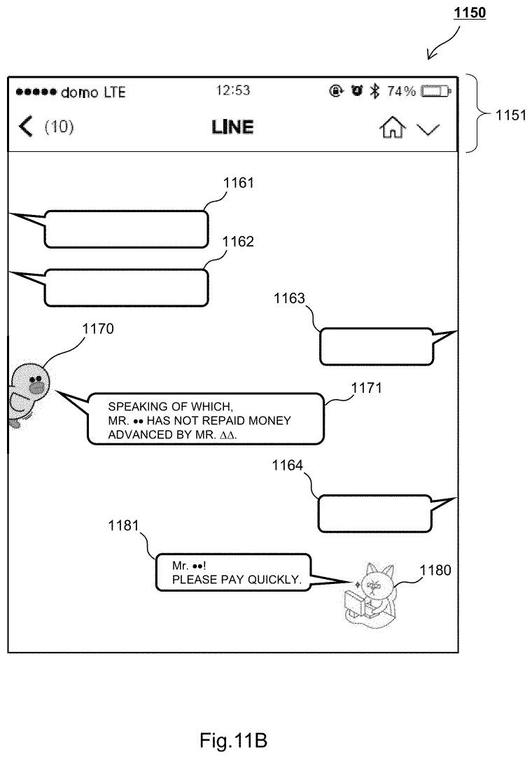

FIG. 11A shows a notification screen example on the user terminal of “friend” as the above described delay notice destination. FIG. 11A shows a screen 1100 of the user terminal of the above described delay notice destination. In addition to a terminal status 1101 displayed on an upper part of the screen 1100, a notice title “Unpaid notification of friend”, an event name display field 1102, an event holding venue and holding date and time display field 1103, and an event cost unpaid amount display field 1104 are displayed.

Further, a message 1105 notifying that the unpaying friend user has not paid the price even after a desired (or alternatively, predetermined) time period elapsed is also displayed.

The friend user who receives this can make a reply of whether or not to notify the unpaying friend that the friend user received the unpaid notification, via an answer field 1106. More specifically, when the friend user notifies the unpaying friend that the friend user received the unpaid notification, the friend user presses a check button 1106a, and presses a check button 1106b when the friend user does not notify the unpaying friend. These instruction commands are recorded and managed by being uploaded to the server or the like, and for example, when the check button 1106a is pressed, the server gives a notice, or the friend member and the unpaying member are controlled to be able to contact each other by being automatically shifted to a talk room for the unpaying friend and the friend user (not shown).

### [Management or the Like of Payment Relationship on Server]

The relationships of guarantee and the like described so far are related to the payment participant list, and are managed on the server, as the next table at the time point when step S409 in FIG. 4A ends.

TABLE 2

| | | | | | | |
|---|---|---|---|---|---|---|
| | | | | | Presence or | |
| Payment | | | | | absence of | |
| participant | Membership | | | | obligation | |
| name | number | Payment | Guarantor | Friend | to repay to | Payment |
| (nickname) | (ID) | amount | (ID) | (ID) | guarantor | deadline |

∘

The payment participants are managed by “name (nickname)” and “membership number (ID)” in the above table though the present inventive concepts are not limited to them (Information concerning the payment participants can be acquired by referring to another table or the like linked to the ID. The same applies hereinafter).

In a “Payment amount” column, for example, the amount calculated in step S408 in FIG. 4A is stored. In a “Guarantor” column, ID of the guarantor (person who guarantees payment of the payment participant) set as described above is stored. When the guarantor is absent, null (null) or the like is inserted. In a “Friend” column, ID of the aforementioned friend is stored. In a “Presence or absence of obligation to repay guarantor” column, presence or absence of obligation to repay the amount advanced by the guarantor (repayment required or unrequired flag) is stored. The repayment required or unrequired flag can be set at the time of the guarantor setting or the like via a screen input field or the like (not shown). In a “Payment deadline” column, payment deadlines by the payment participants are stored. The payment deadline can also be appropriately set via the screen input field or the like (not shown). Individual payment deadlines are managed by the server, and various dunning processes described later are performed to the participants who have not paid even after the payment deadlines.

FIG. 4B is an operation flow more specifically illustrating processes and the like in the case of entering the talk room or the like that is the basis of the communication unit, and transmitting and receiving messages, through the information system according to one example embodiment of the present inventive concepts, and the BOT being present at the time of message reception.

When one user (human user that is not the BOT) enters the talk room by, for example, starting up the application via the user terminal in step S421 in FIG. 4B, the flow proceeds to step S422, and the status information such as a talk list for operating the application and/or information on a read message and the like are read into the memory in the user terminal by being read to the user terminal from the talk server, or being read from the storage device or the like in the user terminal itself.

The talk list is a list of a plurality of talk rooms operated in the talk server, and as one example, as for the talk room of which the user is a member, the user enters the talk room by the selection instruction or the like, and can perform group talk with the other member users. The group talk is progressed by the members exchanging messages (transmitting and receiving to one another) via a messaging service provided by the talk server.

In FIG. 4B, a loop from step S423 to step S431 is an operation loop for communication, and the user can continue transmission and reception of messages with the other members unless the user ends the application (that is, exits the talk room) in step S431. Further, when an assistant BOT (adviser program having a so-called AI function, and the BOT itself can also be caused to participate in the talk room as a user having one account) is linked to the user or the group in the operation loop, the assistant BOT can be caused to give an advice to the user, and can be caused to transfer at least some of the reception messages from the other users to the talk server or the like.

The relationship between the user and the assistant BOT in this case is similar to the relationship between the human users.

When a message or the like is transmitted from the user by an operation not shown in step S423 (Yes), the flow proceeds to step S424, and transmission processing of the message or the like to the talk server is performed (in the case of No in step S423, the flow proceeds to step S425). Though not shown in FIG. 4B, operation examples processed according to a content of the message or the like transmitted in step S424 are as the following (1) to (3).

(1) When the Message of the User Himself or Herself is Transmitted to the Talk Server from the User Terminal

The talk server transmits (transfers) the received message to the other members in the talk room. Further, if desired, the talk server extracts one or more BOT candidates relating to the received message (in other words, capable of appropriate response to the received message) and can cause the BOT candidate to send a reply to the user who sent the message and/or the other members in the talk room.

In one example embodiment of the present inventive concepts, these BOT candidates include BOT_IDs linked to the BOTs, character images expressing the respective BOTs, and/or messages expressing remarks of the BOTs.

(2) When BOT_ID (Described Above) is Transmitted from the User Terminal to the Talk Server

The talk server can also make a request to a corresponding BOT (BOT server) based on the specified BOT_ID. In one example embodiment of the present inventive concepts, the talk server makes a request for a content candidate prepared by the BOT server at a present time point (that is, providable along a flow of conversation in the talk room at that time point) to the BOT server.

Note that in one example embodiment, BOT_ID may be transmitted with the message of the user.

(3) When a Content is Transmitted or Specified to the Talk Server from the User Terminal

The talk server transmits (transfers) the content (text/audio information or image information, links to specific sites or the like is cited) which is transmitted or specified by the user to the other members in the group.

When there is reception of messages or the like to the user in step S425 (Yes), the flow proceeds to step S426, and it is determined whether or not the assistant BOT is present in (that is, is linked to) the user (or a talk group (or chat group) in which the user participates), and in the case of Yes, the flow proceeds to step S427a to select some or all of the messages (already received in step S425). Subsequently, the flow proceeds to step S427b, the messages are transferred to the talk server via the assistant BOT, and the flow proceeds to step S428 (in the case of No in step S426, the flow directly proceeds to S428).

In step S427a to step S427b, messages of what degree of the received messages are transferred to the talk server via the assistant BOT depends on the permission setting by the user, but a dunning BOT described later can be operated so as not to be set to be unpermitted (that is, to be always permitted).

Further, as for timing of the above described transfer, for example, variations such as (1) each time a message is received, at least a part of the message is transferred to the talk server, and (2) each time the received message is displayed on the terminal, at least a part of the message is transferred to the talk server can be applied.

Further, when at least a part of the reception message is transferred to the talk server in the timing of the above described transfer, control can be performed so that a message that is received but is not displayed on the terminal can be transferred to the talk server with the part of the message.

In step S428, the received message or the like is displayed on the user terminal.

When there is reception of object display to the user in step S429 (Yes), the flow proceeds to step S430, and processing is appropriately performed concerning a way of showing the received object on the terminal. Subsequently, the flow proceeds to step S431 (in the case of No in step S429, the flow directly proceeds to step S431).

When a talk room exit instruction is given by a user operation not shown in step S431, the present flow ends (step S432). In the case of No in step S431, the flow returns to step S423.

FIG. 4C is an operation flow shown mainly from a viewpoint of the talk server.

When the talk server starts processing in step S451 in FIG. 4C, the flow proceeds to step S452, and various kinds of status information and the like for operating the talk room are read into the memory in the server.

In FIG. 4C, a loop from step S453 to step S461 is an operation loop of the talk server that operates communications among the users, and the talk server waits for arrival of a message and the like (e.g., a message including BOT_ID, a message not including BOT_ID, or a message having only BOT_ID) or a content (content itself or including a specifying message for specifying the content), as long as the process is ended in step S461.

In step S453, whether or not there is reception of a message or the like is determined, the flow proceeds to step S459 in the case of No, whereas in the case of Yes, the flow further proceeds to step S454, and whether the received message or the like includes BOT_ID is determined. In the case of No in step S454, it is reception of a message or the like from another user, so that the flow proceeds to step S457, and processing for extracting or specifying a BOT (there may be more than one BOT) capable of response according to the received message content is performed. In one example embodiment, extraction or specifying processing of the BOT is realized by inquiry and response to the BOT serer (group) from the talk server.

Subsequently, in step S458, the BOT candidate extracted or specified in the previous step is transmitted to the other user in the talk group, and the flow proceeds to step S459.

Note that step S457 and step S458 may be omitted appropriately in some example embodiments.

On the other hand, in the case of Yes in step S454, the received message is typically specification to the BOT candidate (already presented), so that the flow proceeds to step S455, and the server transmits a request for a content or a content candidate to the specific BOT (server) specified. Next, when the content candidate is transmitted from the specific BOT (server), the server transmits the content candidate received in step S456 to the user terminal which is the message transmission source, also transmits the aforementioned content candidate to the terminals of the other users via the user terminal (or without going through the user terminal), and realizes real-time content sharing. Subsequently, the flow proceeds to step S459.

In step S459, whether or not there is reception of a content itself of a specifying message to a content is determined, the flow proceeds to step S460 in the case of Yes, and the server transmits the content to the other user in the group (the flow proceeds to step S461 in the case of No in step S459). When the received message is the specifying message to the content (as one example, content information that can be obtained by specifying the URL) at this time, the talk server acquires the content and transmits the content to the other users in the group. Subsequently, the flow proceeds to step S461.

In step S461, whether or not to end the operation as the talk server is determined, the flow proceeds to step S462 and the present flow ends when the operation of the talk server is ended by the operation not shown (Yes in step S461), whereas in the case of No in step S461, the flow returns to step S453.

### [Summary of Function Module for Executing the Accounting Flow Such as Payment]

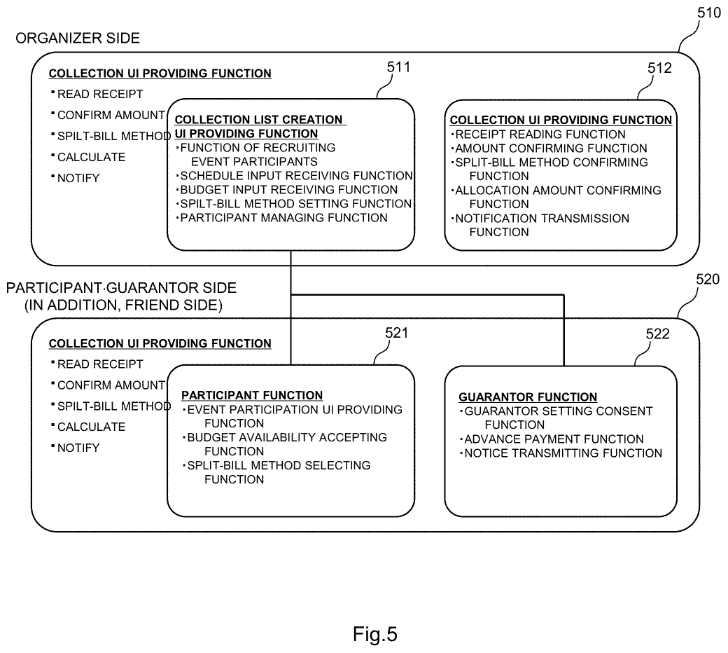

FIG. 5 shows function concepts of an operation in the system and the like according to one example embodiment of the present inventive concepts. For example, the respective functions described with reference to FIG. 2 to FIG. 4C correspond to processing units implemented in the control device 1110 (server side) and/or the control device 1510 (terminal side) in FIG. 1, and therefore the respective functions will be described here.

As described so far, the system and the like according to one example embodiment of the present inventive concepts broadly includes a collection UI and the like providing function 510 on the organizer terminal and a collection UI providing function 520 on the terminals of the participants, guarantors, the other friends and the like, and these functions cooperate or are synchronized with the server 110 and the like appropriately (with this, the organizer terminal and the terminals of the participants and the like cooperate with one another). Entities of the respective functions are realized as various functions that the control device 1110 and/or the control device 1510 are configured to execute by reading various programs and various data stored in the storage devices 1105 and/or 1515 appropriately. The same applies to lower functions described below.

In FIG. 5, the collection UI and the like providing function 510 on the organizer terminal includes the reading function of a receipt and the like, the amount confirming (totaling) function, the bill splitting method and the like selection function, the various calculation functions, and the various notification functions, as described above. For example, the collection UI is divided into a collection list creation UI providing function 511 and a collection UI providing function 512, which respectively have sub functions as in the following table.

TABLE 3

| | |
|---|---|
| Configuration of collection | Function for recruiting event participants |
| list creation UI providing | Schedule input receiving function |
| function 511 | Budget input receiving function |
| | Split-bill method setting function |
| | Participant managing function |
| Configuration of collection | Receipt reading•recognizing function |
| UI providing function 512 | Amount confirming function |
| | Split-bill method confirming function |
| | Allocation amount confirming function |
| | Notification/transmission function |

Further, the collection UI and the like providing function 520 on the terminals of the participants and the like also includes the reading function of a receipt and the like, the amount confirming (totaling) function, the bill splitting method and the like selecting function, the various calculation functions, and the various notification functions as described above. For example, the collection UI is divided into a participant function 521 and a guarantor function 522, which respectively have sub functions as in the following table.

TABLE 4

| | |
|---|---|
| Configuration of | Event participation UI providing |
| participant function 521 | function |
| | Budget availability receiving function |
| | Split-bill method selecting function |
| Configuration of | Guarantor setting consent function |
| guarantor function 522 | Advance payment function |
| | Notification/transmission function |

### Second Example Embodiment

A second example embodiment describes payment and exchanges of messages and the like among a plurality of user terminals (as examples, an organizer terminal and participant terminals A to C, guarantor terminals that may be participants, friend terminals) as an operation scene of an entire system. As is obvious in explanation of the talk room, a server is also involved in message exchanges among the user terminals, but here, for easy understanding, presence of the server is omitted (actually, the server is appropriately involved).

Some or all of the contents described in the second example embodiment are also applicable to the other example embodiments except where features thereof are mutually exclusive.

Further, operations or processing times (t1 and the like) illustrated in the example embodiment are illustrated for easy understanding of the present inventive concepts, and the present inventive concepts are not limited to individual time-series relationships illustrated in the example embodiment (hereinafter, the same applies to some example embodiments illustrating times clearly). Further, what is described as exchanges between people is exchanges between terminals owned by the respective people, or exchanges between terminals via the server.

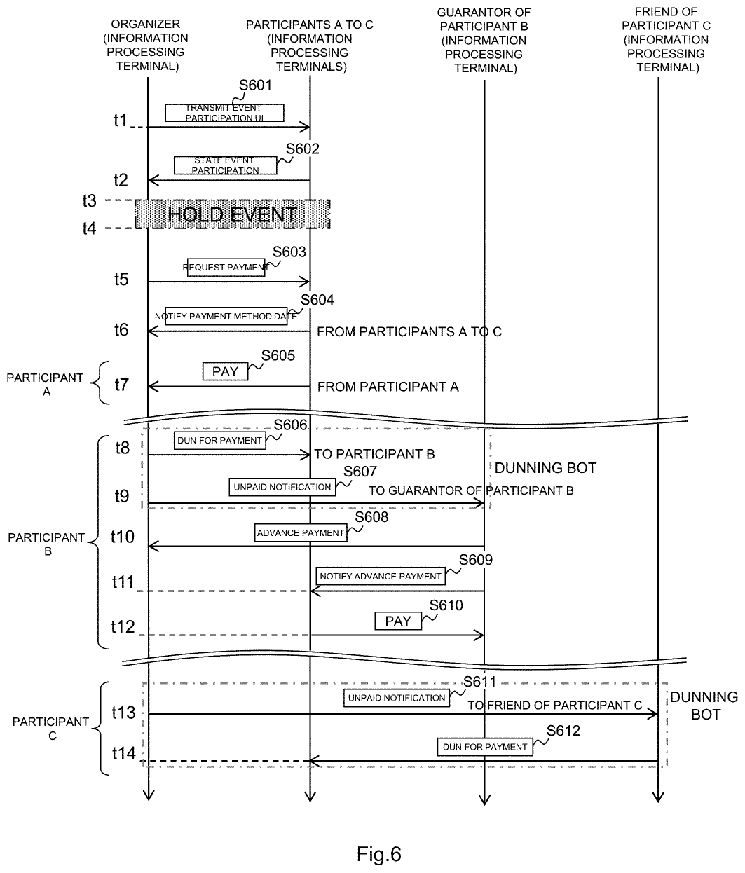

Hereinafter, FIG. 6 is referred to and explained.

In one example embodiment of the present inventive concepts shown in FIG. 6, an event page is created on the organizer terminal by a time t1, a participant list to be invited in advance (pre-participant list) is created, and event participation UI is transmitted to invited members (A to C) (step S601). Next, at a time t2, an event participation statement is returned from each of the terminals (step S602). In the time t2 in FIG. 6, the number of arrows expressing the event participation statement is only one for convenience of explanation, but a plurality of participants return the statement (hereinafter, the same applies to respective processes of notification, payment and the like described later except where a special notice is given as described in step S305).

From a time t3 to a time t4, the event is carried out in a venue not shown. In one example embodiment of the present inventive concepts, the participants participate in the event with their own terminals.

Next, by a time t5, the organizer makes a payment request to the participants for expenses incurred during the event (step S603). Though the present inventive concepts are not limited to this, the organizer can once make an advance lump-sum payment (and thereafter charge the respective participants), or can proceed with processing so as to collect the cost from each terminal (and thereafter make a lump-sum payment) so that the organizer makes a lump-sum payment.

At a time t6, participants A to C send notices about a payment method and a payment date (payment deadline) from terminals of their own to the organizer terminal (step S604). Information on them can also be recorded and managed by the server (hereinafter, the same applies to the information exchanged among the terminals).

From now, for understanding of the present inventive concepts, responses of the participants A to C (and responses to the participants A to C) are made different, and explanation will be continued on the premise thereof.

### [Response of Participant A]

At a time t7, payment to the organizer is made by the participant A (step S605). In one example embodiment of the present inventive concepts, electronic value is remitted (transmitted or transferred) from the terminal of the participant A to the organizer terminal, but the present inventive concepts are not limited to this, and any information processing that is essential for settlement or the like to be performed finally may be used.

### [Response to the Participant B and the Like]

A time t8 to a time t12 corresponds to an operation flow showing response examples to a participant B and a guarantor of the participant B. At the time t8, a desired (or alternatively, predetermined) time period has elapsed already from the time t6. More specifically, the deadline of payment of the participant B to the organizer has passed (in some cases significantly). At the time t8, first, dunning notice for payment is given to the participant B from the organizer (step S606). A transmitter of the dunning notice does not always have to be the organizer terminal, but the dunning notice may be made by the server as a subject based on deadline management of the server (hereinafter, the same applies to a subject of notification and the like).

A time t9 may be a time at which a desired (or alternatively, predetermined) time has further elapsed from the time t8, or may be directly after the time t8. At the time t9, an unpaid notice of the participant B is sent from the organizer terminal (or the server) to the terminal of the guarantor of the participant B (step S607). The notification screen example may be a simple unpaid notice (not shown), but the present inventive concepts are not limited to this, and the notification screen may be notification of inquiry about whether to advance or not as illustrated with reference to FIG. 10 (in the present operation flow, notice of inquiry about whether to advance or not to the guarantor is adopted).

Further, prior to the notice of inquiry about whether to advance or not to the guarantor, the aforementioned unpaid notice may be performed.

A notification subject as the application in step S606 and step S607 may be the BOT already described (dunning processing by a so-called dunning BOT).

In this case, the BOT can be caused to perform dunning and/or notification exceeding disallow setting of a dunning destination and/or a notification destination user in step S606 and S607 (this is to prevent contact and the like of the BOT from being rejected by the disallow setting of the dunning destination and/or notification destination user).

At a time t10, the guarantor of the participant B agrees to advance payment of the cost of the participant B, and advance payment processing from the guarantor to the organizer is performed (step S608). As a specific example, payment by electronic value is performed though payment is not limited to this.

At a time t11, advance payment notification from the guarantor of the participant B to the participant B is performed (step S609), and at a time t12, payment (so-called repayment) from the participant B to the guarantor of the participant B is performed (step S610). As one example embodiment of the present inventive concepts, repayment is performed in step S610 because the guarantee relationship between the participant B and the guarantor of the participant B is registered or set as having a repayment obligation at the time of advance. When the guarantee relationship between the participant B and the guarantor of the participant B registered as having no repayment obligation is established, step S610 is may be omitted.

### [Response to Participant C]

From a time t13 to a time t14 corresponds to an operation flow showing a response example to the participant C and a friend of the participant C. The time t13 is a time at which a desired (or alternatively, predetermined) time period has already elapsed from the time t6. For example, the time t13 is a time at which a deadline of payment of the participant C to the organizer has passed. At the time t13, unpaid notice from the organizer to the friend of the participant C is made first (step S611). A transmitter of the unpaid notice does not have to be always the organizer terminal, but the unpaid notice may be performed by the server as the subject based on the deadline management of the server (hereinafter, the same applies). A notification screen example of the unpaid notice to the friend of the participant is as described with reference to FIG. 11A.

At the time t14, the friend of the participant C performs dunning for payment to the participant C (step S612). Because the participant C is prompted by the close friend instead of being prompted by the organizer, it is expected that the participant C will make payment to the organizer quickly.

A notification subject as the application in step S611 and step S612 may be the BOT already described (dunning processing by a so-called dunning BOT).

In this case, the BOT can be caused to perform dunning and/or notification exceeding disallow setting of the dunning destination and/or notification destination user in step S611 and step S612 (this is to prevent contact or the like of the BOT from being rejected by the disallow setting of the dunning destination and/or the notification destination user).

For example, FIG. 11B shows a notification screen example in the case of performing variation of the third party notification by the BOT. FIG. 11B shows a screen 1150 of the user terminal that performs communication in the talk room, and in addition to a terminal status 1501 displayed on an upper part of the screen 1150, various messages are displayed in time-series (flow from top to bottom) in the talk room screen.

In the talk room screen, messages 1161 and 1162 are sent from a user terminal other than the user terminal that displays the screen, and messages 1163 and 1164 are transmitted from the user terminal that displays the screen.

Messages 1171 and 1181 are messages in which the BOT judges a flow of exchange of the aforementioned messages and duns and notifies a non-payer ●●.

As one example of the present inventive concepts, one or more conditions under which the messages 1170 and 1180 occur are considered to be as follows.

(1) A certain period of time has further elapsed after a payment deadline of the non-payer passed.

(2) The non-payer, or a friend or a guarantor of the non-payer is participating in the talk room.

FIG. 11B shows a dunning notice example in the case with an advance repayment obligation, but the present inventive concepts are not limited to this, and it is also possible to cause the BOT to give a thanks dunning notice in the case without an advance repayment obligation. In this case, the message 1170 is, “Speaking of which, Mr. ●● has not yet said thank you to Mr. ΔΔ for advancing payment on his behalf” or the like, and the message 1180 is “Mr. ●●! You should say thank you to Mr. ΔΔ” or the like. Such thank-you dunning also contributes to improving manners in social messaging.

As a matter of course, in the case without an obligation to repay the advance, it is possible to operate the BOT so that the BOT does not specially give a dunning notice.

### Third Example Embodiment

A third example embodiment describes a variation of the present inventive concepts that remits money to the group from a third party. According to the variation, remittance from a third party inside or outside the group who does not participate in an event but would like to provide (donate) money to the group (or a sub group composed of members who participate in the event) is realized. Further, a remittance method of the present example embodiment is also applicable to electronic red packaging (online new year gift that is electronic money sent via an information processing terminal) that has become popular in recent years.

Some or all of the contents described in the third example embodiment is also applicable to the other example embodiments except where the features thereof are mutually exclusive.

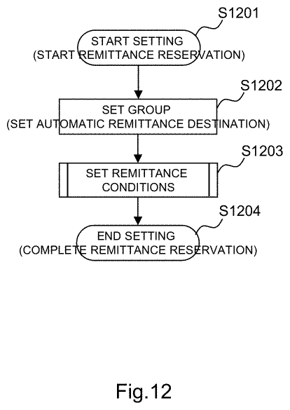

FIG. 12 shows an operation flow. When a remittance reservation setting processing is started via a terminal screen (not shown) in step S1201 in FIG. 12, the flow proceeds to step S1202, and a remittance destination group is set. In one example embodiment of the present inventive concepts, remittance is automatically performed, and remittance conditions for this are set via a setting screen (not shown) in following step S123.

Further, as the feature of the present inventive concepts, the remittance destination can be set not only for a plurality of individuals but also for each group. When the remittance destination is set for a plurality of individuals, the remittance destination after the setting is fixed, but when it is set for each group, even when the members composing the group change, it becomes possible to remit money to the composing members at the time point at which the remittance is performed (the remittance mentioned here has the same intended meaning as the transmission or transfer between terminals of electronic value that are described so far. The same applies hereinafter).

Because the remittance destination settings for each group can be made, even when a contribution or a donation is made to the aforementioned event participation type group, a contribution or a donation can be made accurately and reliably to the participation members confirmed at the end, at the start of the event.

In step S1203, the remittance conditions are set. Setting of the conditions can be performed for remittance timing and distribution at the time of remittance. As the remittance timing, the following timings can be considered although the present inventive concepts are not limited to these timings.

(1) When any event that the group is working on is completed.

(2) When a good result is achieved in efforts (test, competition or the like) of the remitter (or recipient).

Further, as for distribution at the time of remittance, the followings are considered.

(1) Leave to the group representative.

(2) Evenly distribute to group members.

(3) Distribute according to the achievement of each member in the event that the group is working on.

When the remittance condition setting of the above is completed, the flow proceeds to step S1204, and remittance reservation setting processing is completed.

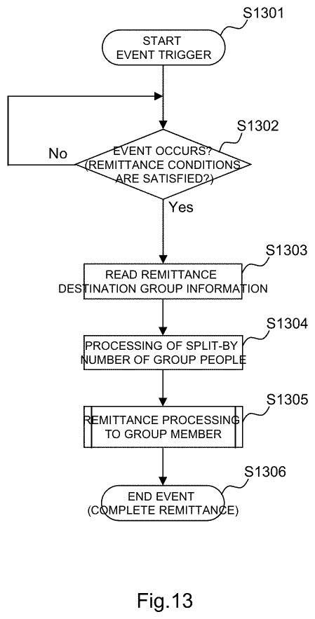

FIG. 13 shows what processing is performed on the server (or a remittance server) side after the remittance reservation setting by the remitter (reserver) described with reference to FIG. 12 is completed.

When an event trigger or an event handler is started based on (the condition concerning the remittance timing) of the remittance conditions set in FIG. 12 in step S1301, the flow proceeds to step S1302, and whether the event satisfying the remittance conditions (or the payment conditions) occurs or not. In the case of No in step S1302, the flow returns to step S1302 (in a so-called event waiting state), whereas in the case of Yes, the flow proceeds to step S1303.

In step S1303, remittance destination group information is read. At this time, belonging members at this point of time are read, so that when a specific event participation group is recruited in a certain group, remittance to the specific participation group is allocated to the participants at this point of time. In some example embodiments, as another example embodiment of the present inventive concepts, remittances may always be made like a reserve for an entire group.

In step S1304, remittance allocation processing to the members of the group to be remitted is performed, and in step S1305, remittance processing to the group members is carried out. At this time, a remittance completion notice may be given to the remittance source (remitter) as necessary.

Subsequently, the flow proceeds to step S1306, and the remittance processing is completed.

### Fourth Example Embodiment

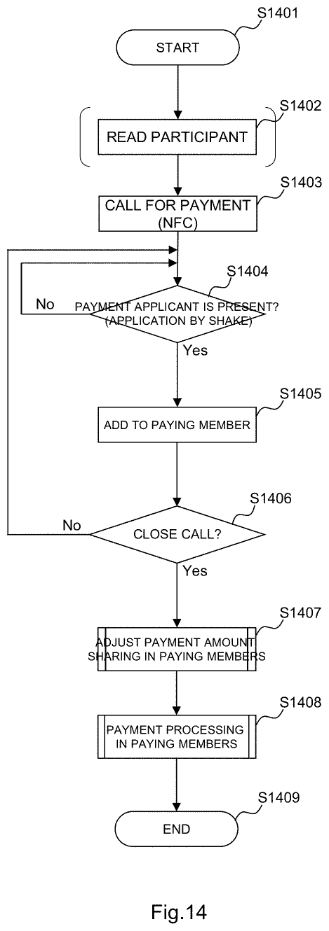

A fourth example embodiment is a variation example of payment request in step S603 in FIG. 6, and describes collection based on split bill processing or sharing payment processing in detail. Hereinafter, the fourth example embodiment will be described with reference to FIG. 14.

Note that some or all of contents described in the fourth example embodiment are also applicable to other example embodiments except where features thereof are mutually exclusive.

When the processing is started in step S1401 in FIG. 14, the flow proceeds to step S1402, and reading of the event participants is performed in the organizer terminal. As for the reading, the registered members in the talk room may be read in the organizer terminal, but the present inventive concepts are not limited to this, and it is operated so as to read members registered in a certain group managed on the server (in other words, in the fourth example embodiment and the following example embodiments, members who participate in the event do not always have to be the members registered in the talk room).

In some example embodiments of the present inventive concepts, some process steps can be omitted (in this case, the process may skip from step S1401 to step S1403).

In step S1403, a call for payment is made from the organizer terminal to the participant terminals present at the place (such as an event venue). In one example embodiment of the present inventive concepts, collection notice using near field communication (NFC) may be given.

In step S1404, the organizer terminal waits for payment applications from the participant terminals that receive the collection notice (a loop with No in step S1404 and returns to the present step). In one example embodiment of the present inventive concepts, payment applications of the participant terminals are performed (transmitted) by near field communication (NFC). In some example embodiments, payment applications are performed (transmitted) by shaking (Shake) the own terminals. In other words, the NFC is performed by the shaking. Here, a shake motion is detected as a swing of the terminal by an acceleration sensor or the like contained in the terminal, and this can be a positive response to the collection notice.

Moreover, the payment application of the participant terminal may be transmitted by other units (transmission unit by sound wave, and magnetism).

In the case of Yes in step S1404, the flow proceeds to step S1405.

In step S1405, application for payment (those who accept payment (e.g., payment obligation)) are added to the paying members. Subsequently, the flow proceeds to step S1406, and whether or not to end payment application (call) is judged. In the judgement, a criteria that the payment application is ended after waiting for the responses of all the participants who are called may be adopted, or the payment application may be terminated on the side of the organizer terminal with a certain number of applications or more. In the case of No in step S1406, the flow returns to step S1404, whereas in the case of Yes, the flow proceeds to step S1407.

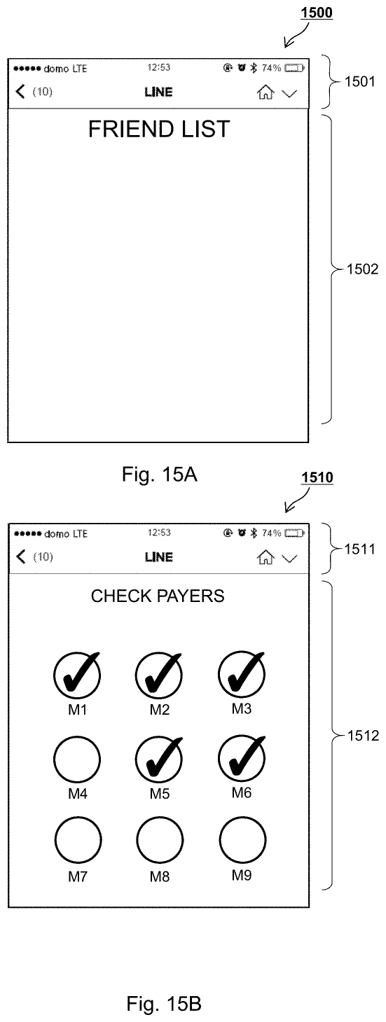

In step S1407, sharing adjustment of the payment amount within paying members is performed. In one example embodiment of the present inventive concepts, equal sharing processing is carried out, but the present inventive concepts are not limited to this, and various kinds of adjustment are possible. Further variations will be described in detail with reference to FIG. 15 and the like.

In step S1408, adjustment processing among the paying members or among the paying members and the other participant members is performed. For example, if there are paying members D, E and F, and D advances the expenses of E and F on behalf of E and F, E and F will repay the advance amounts at a later date. In some example embodiments, at a later date, juniors will pay some percentage (1000 yen for each, for example) of what the senior has advanced on behalf of the juniors (10000 yen, for example).

After the above processing, this flow ends (step S1409).

### Fifth Example Embodiment

A fifth example embodiment describes a feature in one example embodiment of the present inventive concepts by focusing screen display examples on the user terminal. Hereinafter, the fifth example embodiment will be described with reference to FIG. 15 to FIG. 19.

Note that some or all of contents described in the fifth example embodiment are also applicable to other example embodiments except where features thereof are mutually exclusive.

For example, the fifth example embodiment specialized in a user interface does not have to always involve transmission and reception of electronic value among user terminals or via a server, but can be adopted in various applications as a split bill application for cash exchange, or “Visible cost bearing adjustment application”.

In one example embodiment of the present inventive concepts shown in FIG. 15A, a terminal status 1501 is displayed on a display screen of a terminal 1500 (casing part or the like is not shown), and in addition, a friend or event participant list display field 1502 is displayed. In order to display the relevant persons in the display field 1502, call and application (by shake or the like) described in FIG. 14 may be performed, but they are not always desired on the screen in FIG. 15A, and only calling (reading) the friend list or the event participant list already registered on the terminal may be sufficient.

The list is M1 to M9 appearing in FIG. 15B. The M1 to M9 represent individual friends or event participants.

In FIG. 15B, on the display screen of the terminal 1510, the friends or the event participants M1 to M9 read on the friend or event participant list display field 1512 are displayed in addition to the terminal status 1511, and an organizer or the like can specify a person who has to pay on the screen by tapping or the like as guided as “Check the payer” on the same screen. In this case, in the venue (restaurant or the like) of an event such as a meal, it is sufficient that the organizer confirms those who apply for payment by calling out actually, and therefore communication by NFC or the like described above is not always desired (of course, confirmation may be taken by NFC communication or the like).

In one example embodiment of the present inventive concepts, M1 to M3, M5 and M6 accept payment obligation, so that participant marks (circles) in the display field 1512 are respectively tapped or the like, and check marks are entered.

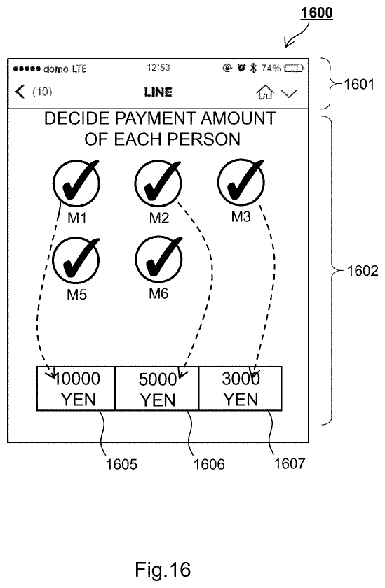

In one example embodiment of the present inventive concepts shown in FIG. 16, a terminal status 1601 is displayed on a screen of a terminal 1600, and in addition, a friend or event participant list display field 1602 is displayed. For convenience of explanation, explaining as continuation of FIGS. 15A and 15B, the participants M1 to M3, M5 and M6 who accept payment obligation are displayed in the display field 1602 with check marks. Here, an interface for deciding respective payment ratios (sharing of payment amount) is provided.

In FIG. 16, a type of payment ratio is decided by a selection menu (not shown) first. As examples, there are the following types.

(1) equal sharing.

(2) stepwise bearing (three-step bearing as shown in FIG. 16 or the like) and the number of steps.

(3) amount of respective steps in the case of (2) described above (as shown in FIG. 16, 10000 yen, 5000 yen, 3000 yen and the like).

In FIG. 16, selection in (2) and (3) described above is performed illustratively, and the bearing in three steps is decided. The bearing amounts in the respective steps are 10000 yen, 5000 yen, and 3000 yen in the order of larger amounts. When such selection is made, in one example embodiment, amount to bear icons (also called payment amount areas) 1605 to 1607 are displayed as shown in FIG. 16.

Next, in order to decide how much amounts the participants M1 to M3, M5 and M6 who accept payment obligation respectively bear, icons of the respective persons are moved to the amount to bear icons by drag and drop or flick operation or the like. In one example embodiment, in FIG. 16, M1 bears 10000 yen, so that an M1 icon is moved to the payment amount area 1605, M2 bears 5000 yen, so that an M2 icon is moved to a payment amount area 1606, and M3 bears 3000 yen, so that an M3 icon is moved to the payment amount area 1607 (M5 and M6 are also moved when the amounts to bear are decided).

Note that when deciding the amounts to bear by stepwise bearing, it is possible to include a fraction of a total amount in a frame with the smallest amount to bear. Further, when a contribution or a donation is previously given from a third party or the like, the bearing ratio deciding processing can be started after the contribution amount or the donation amount is subtracted from the total amount at this point of time.

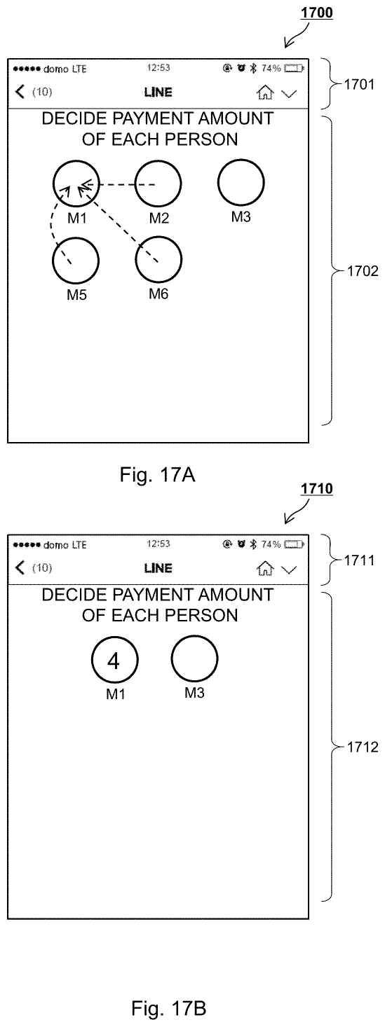

FIGS. 17A and 17B show another deciding method of the payment amounts among the persons who accept payment. In FIGS. 17A and 17B, a terminal status 1701 is displayed on a screen of a terminal 1700, and in addition, a friend or event participant list display field 1702 is displayed. FIGS. 17A and 17B are expressed by being related to FIG. 16 (so that the payers are the same) for convenience of explanation, and can also be understood as continuation of FIG. 15.

In FIG. 17A, icons of payers M1 to M3, M5 and M6 are displayed in the display field 1702, but here adjustment processing of bearers can be performed by the following operations, before or after payment amounts are decided.

(1) When bearing the amounts for the other bearers as well, the bearer icons on the side of the other bearers who have the bearer pay the amounts for the other bearers are overlaid on the icon on the side of the bearer who bears the amounts of the other bearers.

(2) An operation of (1) described above can be executed a plurality of times (repeatedly).

Note that the operation of (1) or (2) described above is also called an integrated operation, or comprehensive processing.

In FIG. 17A, M1 illustratively bears the amounts for M2, M5 and M6 as well, so that the M2 icon is overlaid on the M1 icon by drag and drop or flick operation, and then the M5 and M6 icons are respectively overlaid on the M1 icon (respectively integrated).

Then, as illustrated in FIG. 17B, M1 and M3 remain on the display field 1712, as actual payers (payment windows), and a number of “4” representing the payment amounts for four people including the amount for M1 is displayed in the M1 icon, in the sense that advancements for three people M2, M5 and M6 are included.

With respect to a management table managed by the server or the like, a record or a sub-table (not shown) is extended, on data configuration, and a record that M1 advances the amounts for M2, M5 and M6 as well (or M2, M5 and M6 respectively have M1 bear the expenses) or the like is added.

Note that 1710 and 1711 respectively correspond to 1700 and 1701.

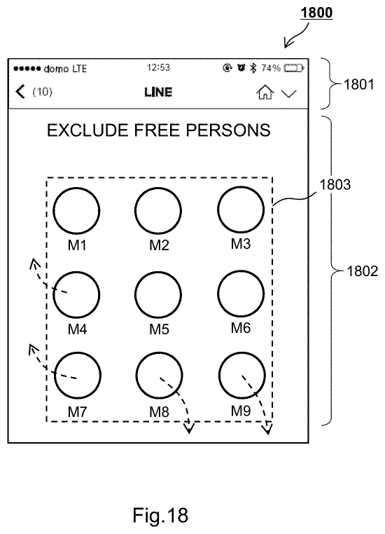

FIG. 18 shows an operation method of easily excluding people who is/are exempted from payment, from the friend or event participant list. An interface function shown in FIG. 18 can also be used as an operation of excluding or exempting people who once accepted payment.

In FIG. 18, a terminal status 1801 is displayed on a screen of a terminal 1800, and in addition, a friend or event participant list display field 1802 is displayed. On the display field 1802, icons of members M1 to M9 are displayed. In one example embodiment of the present inventive concepts, in order to exclude a free person (person exempted from payment) from here, the relevant person can be moved outside a desired (or alternatively, predetermined) frame (frame 1803 in FIG. 18) by drag and drop or flick operation.

In one example embodiment of the present inventive concepts, M4 and M7 to M9 are determined as free people, so that the respective icons are flicked to outside of the frame 1803. As a result, on the management table, borne amounts of the event by M4 and M7 to M9 are recorded and managed as zero.

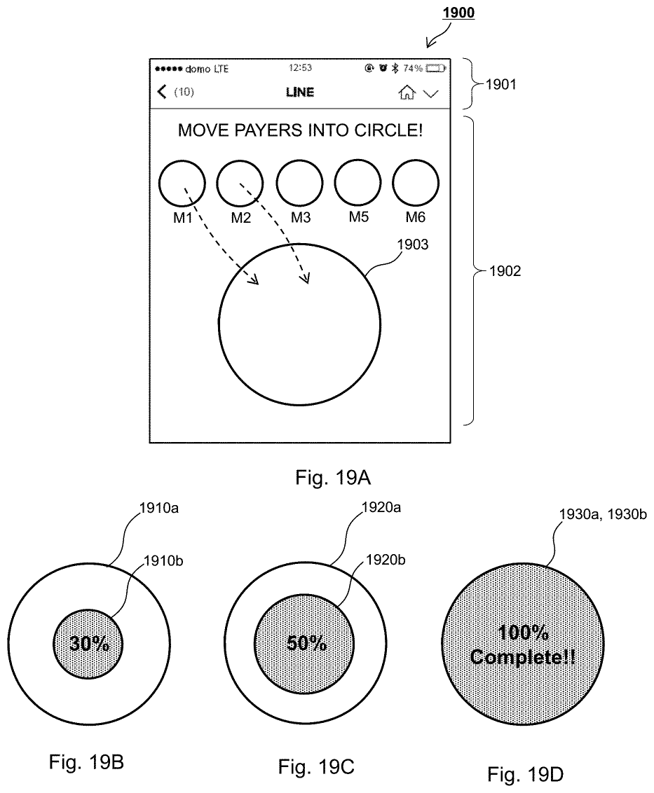

FIG. 19A shows an interface example that is configured so that payment progress rates of the people who accept payment are intuitively recognized visually. In FIG. 19A, a terminal status 1901 is displayed on a screen of a terminal 1900, and in addition, a friend or event participant list display field 1902 is displayed. In the display field 1902, persons M1 to M3, M5 and M6 who accept payment (e.g., payment obligation), and a payment completion confirmation frame 1903 are displayed.

The payment completion confirmation frame 1903 is a confirmation region in which payment situations of the persons accepting payment are confirmable.

In one example embodiment of the present inventive concepts, as for persons who actually completed payment, the relevant icons are sequentially flicked into the frame 1902.

By doing so, an achievement rate of collecting money to the total amount can be visually displayed as in FIGS. 19B to 19D. FIG. 19B shows a state where 30% of the total amount is able to be collected, FIG. 19C shows a state where 50% of the total amount is able to be collected, and FIG. 19(D) shows a state where 100% is able to be collected.

In one example embodiment of the present inventive concepts, FIGS. 19B to 19D show areas corresponding to bearing ratios of the persons accepting payment (or a total payment amount at the point of time). In this sense, a display region of “100% Complete” expressed in FIG. 19D is an area corresponding to a total of bearing ratios of the persons accepting payment, and corresponds to a total area of the confirmation region.

In this way, by adopting the interfaces shown in FIGS. 19A and 19B, cash collecting and accounting at a busy restaurant can be made to proceed smoothly, which is favorable. In this case, the payment method may be transfer of electronic value between terminals, or exchange in cash. In either case, an effect that sharing of cost ratio and collection become easy is provided.

Some example embodiments of the present disclosure are described based on the various drawings and examples, and it should be noted that a person skilled in the art could easily perform various modifications and corrections based on the present disclosure. Accordingly, it should be noted that these modifications and corrections are included in the scope of the present disclosure. For example, it is possible to rearrange functions and the like included in the respective units, the respective steps and the like to be logically consistent, and it is possible to combine a plurality of units, steps and the like to be one, or divide them. Further, the configurations shown in some example embodiments may be appropriately combined.

What is claimed is:

1. A method for performing adjustment of payment between a first user associated with a first information processing terminal registered in a group managed on a server and one or more second users associated with one or more second information processing terminals registered in the group, the method comprising:
displaying the one or more second users associated with the one or more second information processing terminals on a screen of the first information processing terminal, and
selecting persons who accept payment from the displayed one or more second users, via an interface on the screen of the first information processing terminal.

2. An information processing terminal, comprising:
a processor configured to execute computer-readable code such that the processor causes the information processing terminal to perform adjustment processing of payment between users registered in a group managed on a server, the users including a first user associated with the information processing terminal and one or more second users associated with one or more other information processing terminals, the adjustment processing including,
displaying one or more second users on a screen of the information processing terminal, and
accepting an input of selecting persons who accept payment from the displayed one or more second users via an interface on the screen.
